(19) United States
(12) Patent Application Publication
(10) Pub. No.: US 2024/0127438 A1
(43) Pub. Date: Apr. 18, 2024

(54) SYSTEMS AND METHODS FOR IMAGE SEGMENTATION

(71) Applicant: UNITED IMAGING RESEARCH INSTITUTE OF INNOVATIVE MEDICAL EQUIPMENT, Shenzhen (CN)

(72) Inventor: Lecheng JIA, Shenzhen (CN)

(73) Assignee: UNITED IMAGING RESEARCH INSTITUTE OF INNOVATIVE MEDICAL EQUIPMENT, Shenzhen (CN)

(21) Appl. No.: 18/399,618

(22) Filed: Dec. 28, 2023

Related U.S. Application Data
(63) Continuation of application No. PCT/CN2022/106780, filed on Jul. 20, 2022.

(30) Foreign Application Priority Data
Jul. 20, 2021 (CN) 202110817145.0
Nov. 16, 2021 (CN) 202111355498.X

(51) Int. Cl. G06T 7/00; G06T 7/11

(52) U.S. Cl. CPC G06T 7/0012; G06T 7/11; G06T 2200/28; G06T 2207/20081; G06T 2207/30004; G06T 2207/30242

(57) ABSTRACT

The present disclosure provides systems and methods for image segmentation. The methods may include determining, from a target image of a subject, a segmentation range. The methods may include determining a segmentation template corresponding to the segmentation range. The segmentation template may include a list of one or more regions of interest (ROIs) of the subject in the segmentation range. Further, the methods may include segmenting one or more target portions corresponding to the one or more ROIs from the target image using at least one segmentation model corresponding to the segmentation template.

### CROSS-REFERENCE TO RELATED APPLICATIONS

This application is a Continuation of International Application No. PCT/CN2022/106780 filed on Jul. 20, 2022, which claims priority to Chinese Patent Application No. 202110817145.0, filed on Jul. 20, 2021, and Chinese Patent Application No. 202111355498.X, filed on Nov. 16, 2021, the contents of each of which are incorporated herein by reference.

### TECHNICAL FIELD

The present disclosure generally relates to image processing, and more particularly, relates to systems and methods for image segmentation.

### BACKGROUND

With the development of automatic segmentation techniques, segmentation models generated by deep learning techniques are widely used in various fields. Normally, different segmentation models are generated for segmenting different regions of interest (ROIs). For a subject (e.g., a patient) including multiple ROIs to be segmented (e.g., a target region and multiple organs at risk), a user needs to manually retrieve segmentation models corresponding to the multiple ROIs, which is inefficient and susceptible to human errors. Therefore, the timeliness of the segmentation cannot be ensured. In addition, training segmentation models usually require a large count of high-quality labelled samples. The high-quality labelled samples are obtained by manually labelling training samples, which requires a lot of manpower. Therefore, it is desirable to provide systems and methods for image segmentation, which can improve the efficiency of image segmentation and the training of image segmentation models.

### SUMMARY

In one aspect of the present disclosure, a method for image segmentation is provided. The method may include determining, from a target image of a subject, a segmentation range; determining a segmentation template corresponding to the segmentation range, wherein the segmentation template includes a list of one or more regions of interest (ROIs) of the subject in the segmentation range; and segmenting one or more target portions corresponding to the one or more ROIs from the target image using at least one segmentation model corresponding to the segmentation template.

In another aspect of the present disclosure, a method for training sample labelling is provided. The method may include obtaining a plurality of first labelled samples and a plurality of un-labelled samples; generating an image processing model and at least one validation model using the plurality of first labelled samples; and labeling the plurality of un-labelled samples to generate a plurality of second labelled samples based on the image processing model and the at least one validation model.

In another aspect of the present disclosure, a system for image segmentation is provided. The system may include at least one storage device including a set of instructions and at least one processor configured to communicate with the at least one storage device. When executing the set of instructions, the at least one processor may be configured to direct the system to perform operations including determining, from a target image of a subject, a segmentation range; determining a segmentation template corresponding to the segmentation range, wherein the segmentation template includes a list of one or more regions of interest (ROIs) of the subject in the segmentation range; and segmenting one or more target portions corresponding to the one or more ROIs from the target image using at least one segmentation model corresponding to the segmentation template.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary system for image segmentation according to some embodiments of the present disclosure;

FIG. 2 is a block diagram illustrating an exemplary computing device according to some embodiments of the present disclosure;

FIG. 3 is a block diagram illustrating an exemplary processing device according to some embodiments of the present disclosure;

FIG. 4 is a flowchart illustrating an exemplary process for image segmentation according to some embodiments of the present disclosure;

FIG. 5 is a flowchart illustrating an exemplary process for determining a segmentation template corresponding to a segmentation range according to some embodiments of the present disclosure;

FIG. 6 is a schematic diagram illustrating an exemplary process for segmenting a target portion according to some embodiments of the present disclosure;

FIG. 7 is a schematic diagram illustrating an exemplary process for obtaining a segmenting result according to some embodiments of the present disclosure;

FIG. 8 is a block diagram illustrating an exemplary processing device according to some embodiments of the present disclosure;

FIG. 9 is a flowchart illustrating an exemplary process for training sample labelling according to some embodiments of the present disclosure;

FIG. 10 is a schematic diagram illustrating an exemplary process for training sample labelling according to some embodiments of the present disclosure;

FIG. 11 is a flowchart illustrating an exemplary process for obtaining a plurality of first labelled samples according to some embodiments of the present disclosure;

FIG. 12 is a schematic diagram illustrating an exemplary process for training sample labelling according to some embodiments of the present disclosure;

FIG. 13 is a schematic diagram illustrating an exemplary process for generating a first validation model according to some embodiments of the present disclosure;

FIG. 14 is a schematic diagram illustrating an exemplary process for generating a second validation model according to some embodiments of the present disclosure;

FIG. 15 is a flowchart illustrating an exemplary process for generating a second labelled sample according to some embodiments of the present disclosure;

FIG. 16 is a flowchart illustrating an exemplary process for updating an image processing model and at least one validation model according to some embodiments of the present disclosure;

FIG. 17 is a schematic diagram illustrating an exemplary process for updating an image processing model and at least one validation model according to some embodiments of the present disclosure; and

FIG. 18 is a diagram illustrating an exemplary computing device according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms (“a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that when a unit, engine, module, or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

In the present disclosure, the subject may include a biological object and/or a non-biological object. The biological object may be a human being, an animal, a plant, or a specific portion, organ, and/or tissue thereof. For example, the subject may include the head, the neck, the thorax, the heart, the stomach, a blood vessel, a soft tissue, a tumor, a nodule, or the like, or any combination thereof. In some embodiments, the subject may be a man-made composition of organic and/or inorganic matters that are with or without life. The terms “object” and “subject” are used interchangeably in the present disclosure.

In the present disclosure, the term “image” may refer to a two-dimensional (2D) image, a three-dimensional (3D) image, or a four-dimensional (4D) image (e.g., a time series of 3D images). In some embodiments, the term “image” may refer to an image of a region (e.g., a region of interest (ROI)) of a subject. In some embodiment, the image may be a medical image, an optical image, etc.

In the present disclosure, a representation of an object (e.g., a subject, a patient, or a portion thereof) in an image may be referred to as “object” for brevity. For instance, a representation of an organ, tissue (e.g., a heart, a liver, a lung), or an ROI in an image may be referred to as the organ, tissue, or ROI, for brevity. Further, an image including a representation of an object, or a portion thereof, may be referred to as an image of the object, or a portion thereof, or an image including the object, or a portion thereof, for brevity. Still further, an operation performed on a representation of an object, or a portion thereof, in an image may be referred to as an operation performed on the object, or a portion thereof, for brevity. For instance, a segmentation of a portion of an image including a representation of an ROI from the image may be referred to as a segmentation of the ROI for brevity.

The present disclosure relates to systems and methods for image segmentation. The systems may determine a segmentation range from a target image of a subject. The systems may also determine a segmentation template corresponding to the segmentation range. The segmentation template may include a list of one or more ROIs of the subject in the segmentation range. Further, the systems may segment one or more target portions corresponding to the one or more ROIs from the target image using at least one segmentation model corresponding to the segmentation template. Since different segmentation ranges (e.g., the head, the chest, the abdomen, etc.) correspond to different segmentation templates, by using the segmentation template, the efficiency of determining the one or more ROIs in the segmentation range may be improved. In addition, the one or more ROIs in the segmentation template may include a plurality of ROIs, and the plurality of ROIs may be classified into a first classification corresponding to targets and a second classification corresponding to organs-at-risk (OARs). The at least one segmentation model may be determined based on the segmentation template (or the first classification and the second classification), which may determine suitable segmentation model(s) for image segmentation, thereby improving the accuracy, efficiency, and flexibility of image segmentation.

Another aspect of the present disclosure, systems and methods for training sample labelling may be provided. The systems may automatically label a plurality of un-labelled samples to generate a large count of high-quality labelled samples, which may reduce labor consumption and improve the efficiency of the training sample labelling. The large count of high-quality labelled samples may be used to train the at least one segmentation model, which may improve the accuracy of the at least one segmentation model, thereby improving the efficiency and accuracy of image segmentation.

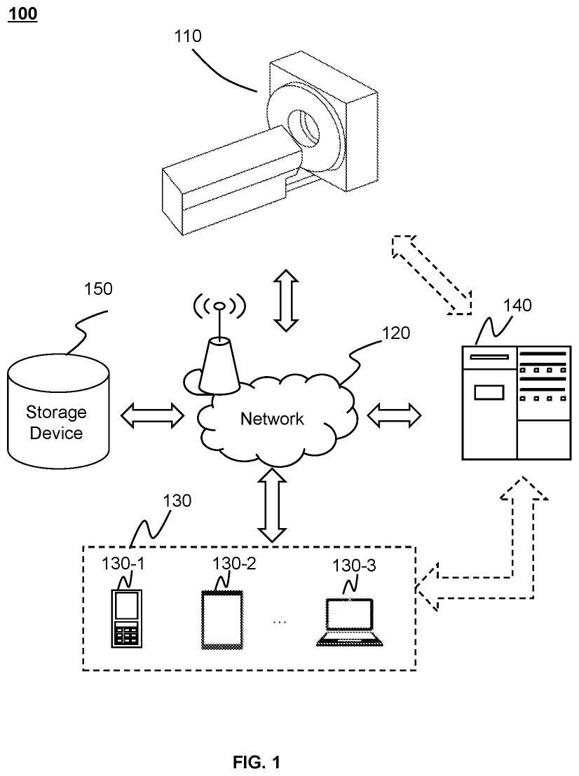

FIG. 1 is a schematic diagram illustrating an exemplary system 100 for image segmentation according to some embodiments of the present disclosure. As shown in FIG. 1, the system 100 for image segmentation may include an imaging device 110, a network 120, one or more terminals 130, a processing device 140, and a storage device 150. In some embodiments, the imaging device 110, the processing device 140, the storage device 150, and/or the terminal(s) 130 may be connected to and/or communicate with each other via a wireless connection (e.g., the network 120), a wired connection, or a combination thereof. The connection between the components in the system 100 for image segmentation may be variable. Merely by way of example, the imaging device 110 may be connected to the processing device 140 through the network 120, as illustrated in FIG. 1. As another example, the imaging device 110 may be connected to the processing device 140 directly. As a further example, the storage device 150 may be connected to the processing device 140 through the network 120, as illustrated in FIG. 1, or connected to the processing device 140 directly.

The imaging device 110 may be configured to acquire scan data relating to at least one part of a subject. For example, the imaging device 110 may scan the subject or a portion thereof that is located within its detection region and generate scan data (e.g., a target image) relating to the subject or the portion thereof. The scan data relating to at least one part of a subject may include an image (e.g., an image slice), projection data, or a combination thereof. In some embodiments, the imaging device 110 may include a single modality imaging device. For example, the imaging device 110 may include a computed tomography (CT) device, a magnetic resonance imaging (MRI) device, a positron emission tomography (PET) device, an X-ray imaging device, a single-photon emission computed tomography (SPECT) device, an ultrasound device, an X-ray device, or the like. In some embodiments, the imaging device 110 may include a multi-modality imaging device. Exemplary multi-modality imaging devices may include a positron emission tomography-computed tomography (PET-CT) device, a positron emission tomography-magnetic resonance imaging (PET-MRI) device, a computed tomography-magnetic resonance imaging (CT-MRI) device, or the like. The multi-modality scanner may perform multi-modality imaging simultaneously. For example, the PET-CT device may generate structural X-ray CT image data and functional PET image data simultaneously in a single scan. The PET-MRI device may generate MRI data and PET data simultaneously in a single scan.

The network 120 may include any suitable network that can facilitate the exchange of information and/or data for the system 100 for image segmentation. In some embodiments, one or more components (e.g., the imaging device 110, the terminal 130, the processing device 140, the storage device 150, etc.) of the system 100 for image segmentation may communicate information and/or data with one or more other components of the system 100 for image segmentation via the network 120. In some embodiments, the network 120 may include one or more network access points. For example, the network 120 may include wired and/or wireless network access points such as base stations and/or internet exchange points through which one or more components of the system 100 for image segmentation may be connected to the network 120 to exchange data and/or information.

The terminal(s) 130 may include a mobile device 130-1, a tablet computer 130-2, a laptop computer 130-3, or the like, or any combination thereof. In some embodiments, the mobile device 130-1 may include a smart home device, a wearable device, a mobile device, a virtual reality device, an augmented reality device, or the like, or any combination thereof. In some embodiments, the terminal(s) 130 may be part of the processing device 140.

The processing device 140 may process data and/or information obtained from one or more components (the imaging device 110, the terminal(s) 130, and/or the storage device 150) of the system 100 for image segmentation. For example, the processing device 140 may segment a target portion representing an ROI from a target image using a segmentation model corresponding to the ROI. As another example, the processing device 140 may label training samples used to train the segmentation model. In some embodiments, the processing device 140 may be a single server or a server group. The server group may be centralized or distributed. In some embodiments, the processing device 140 may be local or remote. For example, the processing device 140 may access information and/or data stored in the imaging device 110, the terminal(s) 130, and/or the storage device 150 via the network 120. As another example, the processing device 140 may be directly connected to the imaging device 110, the terminal(s) 130, and/or the storage device 150 to access stored information and/or data. In some embodiments, the processing device 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the processing device 140 may be implemented by a computing device. For example, the computing device may include a processor, a storage, an input/output (I/O), and a communication port. The processor may execute computer instructions (e.g., program codes) and perform functions of the processing device 140 in accordance with the techniques described herein. The computer instructions may include, for example, routines, programs, objects, components, data structures, procedures, modules, and functions, which perform particular functions described herein. In some embodiments, the processing device 140, or a portion of the processing device 140 may be implemented by a portion of the terminal 130.

Merely for illustration, only one processing device is described in the system 100 for image segmentation. However, it should be noted that the system 100 for image segmentation in the present disclosure may also include multiple processing devices. Thus operations and/or method steps that are performed by one processing device as described in the present disclosure may also be jointly or separately performed by the multiple processing devices. For example, if in the present disclosure the system 100 for image segmentation executes both operation A and operation B, it should be understood that operation A and operation B may also be performed by two or more different processing devices jointly or separately (e.g., a first processing device executes operation A and a second processing device executes operation B, or the first and second processing devices jointly execute operations A and B).

The storage device 150 may store data/information obtained from the imaging device 110, the terminal(s) 130, and/or any other component of the system 100 for image segmentation. In some embodiments, the storage device 150 may include a mass storage, a removable storage, a volatile read-and-write memory, a read-only memory (ROM), or the like, or any combination thereof. In some embodiments, the storage device 150 may store one or more programs and/or instructions to perform exemplary methods described in the present disclosure.

In some embodiments, the storage device 150 may be connected to the network 120 to communicate with one or more other components in the system 100 for image segmentation (e.g., the processing device 140, the terminal(s) 130, etc.). One or more components in the system 100 for image segmentation may access the data or instructions stored in the storage device 150 via the network 120. In some embodiments, the storage device 150 may be directly connected to or communicate with one or more other components in the system 100 for image segmentation (e.g., the processing device 140, the terminal(s) 130, etc.). In some embodiments, the storage device 150 may be part of the processing device 140.

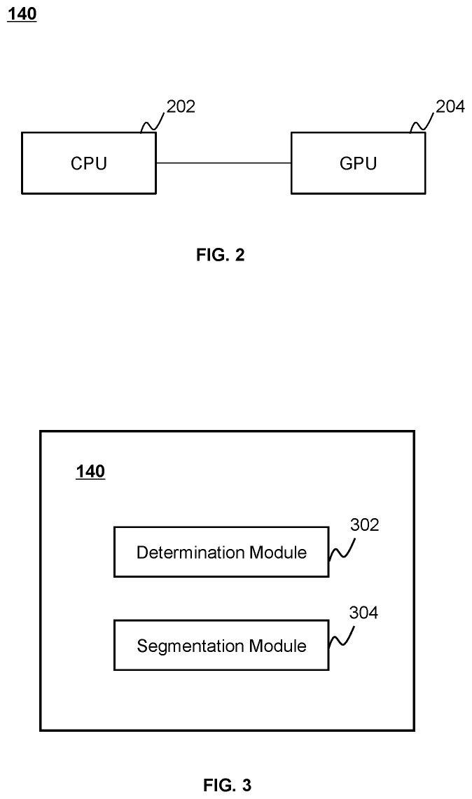

FIG. 2 is a schematic diagram illustrating exemplary processing device 140 according to some embodiments of the present disclosure. As illustrated in FIG. 2, the processing device 140 may include one or more hardware processors, such as a central processing unit (CPU) 202 and a graphics processing unit (GPU) 204 as shown in FIG. 2. In some embodiments, different hardware processors of the processing device 140 may execute different computer instructions. Merely by way of example, the CPU 202 may be configured to obtain a target image, and the GPU 204 may be configured to perform processing operations (e.g., image segmentation) on the target image.

In some embodiments, the storage device 150 may store first instructions for the CPU 202 to execute and second instructions for the GPU 204 to execute. For example, when the first instructions are executed by the CPU 202, the CPU 202 may be directed to obtain a target image of a subject; when the second instructions are executed by the GPU 204, the GPU 204 may be directed to perform exemplary methods for image segmentation disclosed herein on the target image.

FIG. 3 is a block diagram illustrating an exemplary processing device 140 according to some embodiments of the present disclosure. In some embodiments, the modules illustrated in FIG. 3 may be implemented on the GPU 204 of the processing device 140. In some embodiments, the processing device 140 may be in communication with a computer-readable storage medium (e.g., the storage device 150 illustrated in FIG. 1) and may execute instructions stored in the computer-readable storage medium. The processing device 140 may include a determination module 302 and a segmentation module 304.

The determination module 302 may be configured to determine a segmentation range from a target image of a subject. The target image may refer to an image of the subject for image segmentation. The segmentation range may refer to a range in the target image including ROIs that needs to be segmented. determine a segmentation template corresponding to the segmentation range. In some embodiments, the determination module 302 may be further configured to determine a segmentation template corresponding to the segmentation range. The segmentation template corresponding to the segmentation range may include a list of one or more ROIs of the subject in the segmentation range. For example, the determination module 302 may obtain a plurality of segmentation templates, and select the segmentation template corresponding to the segmentation range from the plurality of segmentation templates. More descriptions regarding the determination of the segmentation range and the segmentation template may be found elsewhere in the present disclosure. See, e.g., operations 402 and 404, and relevant descriptions thereof.

The segmentation module 304 may be configured to segment one or more target portions corresponding to the one or more ROIs from the target image using at least one segmentation model corresponding to the segmentation template. In some embodiments, the segmentation template may have one or more corresponding segmentation models. After the segmentation model(s) corresponding to the segmentation template are obtained, the segmentation module 304 may segment the one or more target portions corresponding to the one or more ROIs from the target image using the segmentation model(s) corresponding to the segmentation template. More descriptions regarding the segmentation of the one or more target portions may be found elsewhere in the present disclosure. See, e.g., operation 406 and relevant descriptions thereof.

It should be noted that the above descriptions of the processing device 140 are provided for the purposes of illustration, and are not intended to limit the scope of the present disclosure. For persons having ordinary skills in the art, various variations and modifications may be conducted under the guidance of the present disclosure. However, those variations and modifications do not depart from the scope of the present disclosure. In some embodiments, the processing device 140 may include one or more other modules. For example, the processing device 140 may include a storage module to store data generated by the modules in the processing device 140. In some embodiments, any two of the modules may be combined as a single module, and any one of the modules may be divided into two or more units.

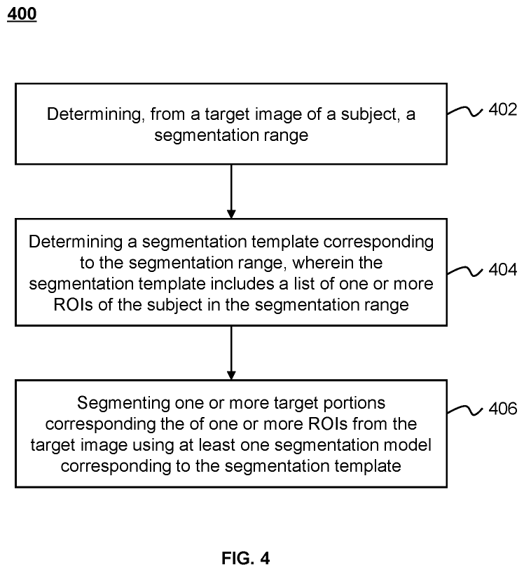

FIG. 4 is a flowchart illustrating an exemplary process for image segmentation according to some embodiments of the present disclosure. Process 400 may be implemented in the system 100 for image segmentation illustrated in FIG. 1. For example, the process 400 may be stored in the storage device 150 in the form of instructions (e.g., an application), and invoked and/or executed by the processing device 140. The operations of the illustrated process presented below are intended to be illustrative. In some embodiments, the process 400 may be accomplished with one or more additional operations not described, and/or without one or more of the operations discussed. Additionally, the order in which the operations of the process 400 as illustrated in FIG. 4 and described below is not intended to be limiting.

In 402, the processing device 140 (e.g., the determination module 302) may determine, from a target image of a subject, a segmentation range.

The target image may refer to an image of the subject for image segmentation. Exemplary target images may include a CT image, an MRI image, a PET image, an ultrasound image, an X-ray image, or the like, or any combination thereof. In some embodiments, the target image may be a 3-dimensional image including a plurality of slices. In some embodiments, the processing device 140 may obtain the target image of the subject from an imaging device (e.g., the imaging device 110) that captures the target image or a storage device (e.g., the storage device 150 or an external storage) that stores the target image.

In some embodiments, after the target image of the subject is obtained, the processing device 140 may preprocess the target image of the subject. Exemplary preprocessing operations may include a size adjustment, image resampling, image normalization, or the like, or any combination thereof.

In some embodiments, the processing device 140 may obtain a plurality of candidate images, and determine an image sequence of the plurality of candidate images (e.g., an image sequence in which the candidate images are sorted according to their priorities, urgency degrees, etc.). The processing device 140 may then select a first candidate image in the image sequence as the target image. Therefore, the candidate image having the highest priority and/or urgency degree may be processed at first, thereby improving the efficiency and accuracy of resource allocation.

For example, the processing device 140 may obtain time information regarding the candidate images, and determine the image sequence of the candidate images based on the time information regarding the candidate images. Merely by way of example, the time information regarding the candidate images may include time limiting information, scanning time, etc., corresponding to the candidate images. The time limiting information of a candidate image may indicate the urgency degree that the candidate image needs to be segmented or the deadline for the segmentation of the candidate image. For example, the time limiting information of the candidate image may be represented as a specific time, such as 8:00 on June 30, 17:30 on July 20, etc. As another example, the time limit information of the candidate image may be represented as an identifier. Different identifiers may be used to represent different urgency degrees. Exemplary identifiers may include colors, numbers, letters, shapes, or the like, or any combination thereof. Merely by way of example, an identifier “1” may indicate that image segmentation needs to be performed on the candidate image within three days. An identifier “2” may indicate that image segmentation needs to be performed on the candidate image within two days. An identifier “3” may indicate that image segmentation needs to be performed on the candidate image within one day. The scanning time of a candidate image may refer to a time when the subject is scanned to obtain scanning data for generating the candidate image. In some embodiments, the scanning time of the candidate image may be recorded as a specific time, such as, 8:00 on June 20, 17:30 on July 25, etc.

In some embodiments, the processing device 140 may obtain the time information regarding the candidate images from an imaging device (e.g., the imaging device 110) or a storage device (e.g., the storage device 150 or an external storage).

In some embodiments, the processing device 140 may obtain the time information regarding a candidate image based on tag information of the candidate image. For example, the candidate image may be stored as a digital imaging and communications in medicine (DICOM) file including a plurality of tags. Exemplary tags in the DICOM file may include patient tags, study tags, series tags, image tags, or the like, or any combination thereof. Each tag may have an identification number, for example, a combination of two hexadecimal numbers, wherein a first hexadecimal number of the two hexadecimal numbers indicates a group of the tag, and a second hexadecimal number of the two hexadecimal numbers indicates an element of the tag. For example, a tag having an identification number of (0010, 0010) may be used to store the name of a patient. In some embodiments, the candidate image may have a specific tag relating to its time limiting information, and the processing device 140 may obtain the time information regarding the candidate image based on the specific tag.

In some embodiments, operation 402 may be performed by the GPU 204 of the processing device 140, and the GPU 204 may obtain the target image of the subject from other hardware processors (e.g., the CPU 202). Merely by way of example, the GPU 204 may send an image acquisition request to the CPU 202. In response to the image acquisition request, the CPU 202 may send the target image of the subject to the GPU 204, and the GPU 204 may receive the target image of the subject.

In some embodiments, before the target image of the subject is sent to the GPU 204, the CPU 202 may preprocess the target image of the subject. Exemplary preprocessing operations may include a size adjustment, image resampling, image normalization, or the like, or any combination thereof. In some embodiments, the CPU 202 may determine the image sequence of a plurality of candidate images, and send the first candidate image in the image sequence to the GPU 204 as the target image. In this way, the GPU 204 may not need to perform operations (e.g., image preprocessing, image sorting, etc.) other than image segmentation, thereby improving the efficiency and the timeliness of the image segmentation performed on the target image.

The segmentation range may refer to a range in the target image including ROIs that needs to be segmented. In some embodiments, the segmentation range may be represented by a serial number range of slices in the target image corresponding to the segmentation range. Merely by way of example, if the target image includes 100 slices, the 100 slices may be numbered from slice 1 to slice 100, and the segmentation range may be represented by a serial number range of slices corresponding to the segmentation range, such as, a range from slice 10 to slice 50, a range from slice 1 to slice 100, a range from slice 20 to slice 40 and from slice 50 to slice 80, etc. In some embodiments, a count (or number) of slices corresponding to the segmentation range may be less than or equal to a total count (or number) of slices in the target image. Merely by way of example, if the total count (or number) of slices in the target image is 100, the count (or number) of slices corresponding to the segmentation range may be less than or equal to 100.

In some embodiments, the processing device 140 may determine an actual size of each of at least one scanned part of the subject based on the target image. The processing device 140 may further determine the segmentation range based on the actual size of each scanned part. For example, the at least one scanned part of the subject may be identified from the target image using an image identification technique (e.g., an image segmentation technique) or manually determined by the user. Exemplary image segmentation techniques may include a region-based segmentation, an edge-based segmentation, a wavelet transform segmentation, a mathematical morphology segmentation, a machine learning-based segmentation technique (e.g., using a trained segmentation model), a genetic algorithm-based segmentation, or the like, or a combination thereof. Then, for each scanned part, the processing device 140 may determine a count of slices that belong to the scanned part, and determine the actual size of the scanned part of the subject based on the count of slices and an actual size corresponding to each slice. Merely by way of example, for each scanned part, the actual size of the scanned part of the subject may be determined by multiplying the count of slices that belong to the scanned part by the actual size corresponding to each slice. The actual size corresponding to each slice may be determined based on a system default of the imaging device (e.g., the imaging device 110). Alternatively, the actual size corresponding to each slice may be obtained based on the tag information corresponding to the target image.

In some embodiments, the processing device 140 may obtain a recognition model. The recognition model may be used to determine the count of slices belonging to each scanned part of the subject. For example, the processing device 140 may input the target image of the subject into the recognition model, and the recognition model may output the count of slices that belong to each scanned part of the subject. As another example, the processing device 140 may input the target image of the subject into the recognition model, and the recognition model may output a ratio of a first count corresponding to each scanned part to a second count. The first count may be a count of slices that belong to the corresponding scanned part, and the second count may be the total count of slices in the target image. For each scanned part, the processing device 140 may determine the first count corresponding to the corresponding scanned part based on the ratio and the second count. As still another example, the processing device 140 may input the target image of the subject into the recognition model, and the recognition model may output a classification result by classifying the slices. For example, the processing device 140 may input slices corresponding to any one of a cross-sectional, coronal, or sagittal plane of the target image into the recognition model, and the recognition model may classify the slices based on their corresponding scanned part. The processing device 140 may determine the count of slices that belong to each scanned part based on the classified slices. Merely by way of example, slices corresponding to the head may be classified into one classification, and slices corresponding to the chest may be classified into another classification. The processing device 140 may determine the count of slices that belong to each scanned part based on the classification result. As another example, the processing device 140 may input three-dimensional data or reconstruction data corresponding to the target image into the recognition model, and the recognition model may classify the three-dimensional data or the reconstructed data based on the scanned part(s). The processing device 140 may determine the count of slices that belong to each scanned part based on the classification result of the three-dimensional data or reconstruction data. Exemplary recognition models may include a deep learning model, such as an image classification model, a target detection model, etc. For each scanned part, the processing device 140 may determine the actual size of the scanned part based on the first count (i.e., the count of slices that belong to the scanned part). For instance, for each scanned part, the processing device 140 may determine the actual size of the scanned part based on the count of slices that belong to the scanned part and the actual size corresponding to each slice.

After the actual size of each scanned part is determined, the processing device 140 may determine the segmentation range based on the actual size. For each scanned part, the processing device 140 may determine whether the scanned part is integral by comparing the actual size with a preset threshold corresponding to the scanned part. If the actual size is larger than or equal to the corresponding preset threshold, the processing device 140 may determine that the scanned part is integral, and correspondingly, determine that the scanned part is within the segmentation range. If the actual size is less than the corresponding preset threshold, the processing device 140 may determine that the scanned part is not integral, and correspondingly, determine that the scanned part is not within the segmentation range.

In some embodiments, the processing device 140 may determine the preset threshold corresponding to each scanned part. That is, different scanned parts may correspond to different preset thresholds. For example, a preset threshold corresponding to the head may be different from a preset threshold corresponding to the chest. In some embodiments, for each scanned part, the processing device 140 may determine the preset threshold based on feature information of the subject (e.g., a patient). For example, a preset threshold corresponding to the head of an adult may be larger than that of a child. As another example, the preset threshold corresponding to the abdomen of a tall patient may be larger than that of a short patient.

Merely by way of example, a target image corresponding to a subject including a lung cancer may be input into the recognition model, and a recognition result output by the recognition model may include a first ratio of a count of slices that belong to the neck to a total count of slices in the target image, a second ratio of a count of slices that belong to the upper abdomen to the total count of slices, and a third ratio of a count of slices that belong to the chest to the total count of slices. If the first ratio is 2%, the second ratio is 2%, the third ratio is 96%, and an actual size of the subject corresponding to the target image is 500 millimeters, a first actual size that belongs to the neck may be 10 millimeters, a second actual size that belongs to the upper abdomen may be 10 millimeters, and a third actual size that belongs to the chest may be 480 millimeters. Correspondingly, the first actual size may be less than a preset threshold corresponding to the neck (e.g., 50 millimeters), the second actual size may be less than a preset threshold corresponding to the upper abdomen (e.g., 70 millimeters), and the third actual size may be larger than a preset threshold corresponding to the chest (e.g., 400 millimeters). Therefore, the chest may be determined as being within the segmentation range, and the neck and the upper abdomen may be determined as being out of the segmentation range. Accordingly, when image segmentation is performed on the target image, the segmentation range in the target image (e.g., slices corresponding to the chest) may be processed. In some embodiments, the target image may be updated by removing slices corresponding to the neck and the upper abdomen, and the updated target image may be determined as the segmentation range.

By determining the actual size of each scanned part of the subject, the segmentation range may be determined efficiently and accurately. In addition, by eliminating redundant parts in the target image, a count of slices to be traversed during the image segmentation may be reduced, thereby improving the efficiency of the image segmentation.

In 404, the processing device 140 (e.g., the determination module 302) may determine a segmentation template corresponding to the segmentation range.

The segmentation template corresponding to the segmentation range may include a list of one or more ROIs of the subject in the segmentation range, for example, one or more ROIs that need to be segmented in the segmentation range. In some embodiments, the ROI(s) in the segmentation template may include a plurality of ROIs, and the plurality of ROIs may be classified into a plurality of classifications having a plurality of ROI identifiers. Merely by way of example, the ROIs may be classified into a first classification corresponding to targets and a second classification corresponding to organs-at-risk (OARs). The first classification and the second classification may correspond to a first ROI identifier and a second ROI identifier, respectively. A target may include a region of the subject including at least part of malignant tissue (e.g., a tumor, a cancer-ridden organ, a non-cancerous target of radiation therapy, etc.). For example, the target may be a lesion (e.g., a tumor, a lump of abnormal tissue), an organ with a lesion, a tissue with a lesion, or any combination thereof, that needs to be treated by, e.g., radiation. An OAR may include an organ and/or a tissue that are close to a target and not intended to be subjected to the treatment, but under the risk of being damaged or affected by the treatment due to its proximity to the target. In some embodiments, each of the first ROI identifier and the second ROI identifier may be determined based on an image identification technique (e.g., an image segmentation technique) or manually determined by the user. Exemplary image segmentation techniques may include a region-based segmentation, an edge-based segmentation, a wavelet transform segmentation, a mathematical morphology segmentation, a machine learning-based segmentation technique (e.g., using a trained segmentation model), a genetic algorithm-based segmentation, or the like, or a combination thereof. In some embodiments, each of the first ROI identifier and the second ROI identifier may be determined based on the tag information corresponding to the target image. For example, the tag information corresponding to the target image may include the range of the target and the range of the OAR, and the at least two ROI identifiers may be determined by retrieving the tag information.

In some embodiments, different targets may have different OARs. For example, if the target is a tumor on the head or neck, the OARs may include the temporal lobe, the optic nerve, the lens, the brain stem, the pituitary gland, the cord, the temporomandibular joint, the parotid gland, the mandible, etc. As another example, if the target is a tumor on the chest tumor, the OARs may include the lung, the esophagus, the heart, the liver, the cord, etc. As still another example, if the target is a tumor on the abdominal or the pelvic, the OARs may include the liver, the spleen, the kidney, the pancreas, the intestine, the colon, the bladder, the penis, the testiculus, the uterus, the hip joint, the femral head, the cord, etc. In some embodiments, the processing device 140 may determine the OAR(s) based on the segmentation range and the target. For example, the processing device 140 may select preliminary OARs in the segmentation range, and determine the OAR(s) based on the target. In some embodiments, the processing device 140 may select preliminary OARs corresponding to the target, and determine the OAR(s) based on the segmentation range.

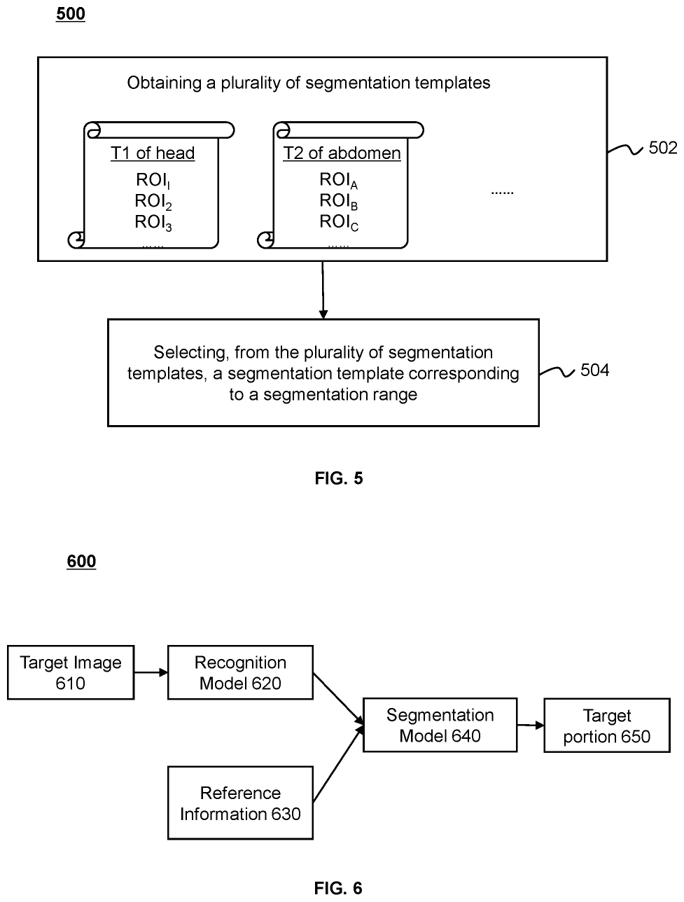

In some embodiments, the processing device 140 may obtain a plurality of segmentation templates. Further, the processing device 140 may select, from the plurality of segmentation templates, the segmentation template corresponding to the segmentation range. More descriptions regarding the determination of the segmentation template corresponding to the segmentation range may be found elsewhere in the present disclosure (e.g., FIG. 5 and the descriptions thereof).

In some embodiments, the processing device 140 may obtain multiple segmentation templates corresponding to the segmentation range. Accordingly, the processing device 140 may determine a union of ROIs in the multiple segmentation templates.

In 406, the processing device 140 (e.g., the segmentation module 304) may segment one or more target portions corresponding to the one or more ROIs from the target image using at least one segmentation model corresponding to the segmentation template.

In some embodiments, the segmentation template may have one or more corresponding segmentation models. For example, the segmentation template may correspond to one segmentation model which includes the first segmentation algorithm(s) for segmenting the target(s) of the subject and the second segmentation algorithm(s) for segmenting the OAR(s) of the subject. Correspondingly, the segmentation model may be used to segment the plurality of ROIs (e.g., the target(s) and/or the OAR(s)) in the segmentation template, thereby further improving the efficiency, flexibility, and accuracy of the image segmentation. For another example, the segmentation template may correspond to a plurality of segmentation models each of which corresponds to one of a plurality of ROIs in the segmentation template. A segmentation model corresponding to an ROI may include a segmentation algorithm used to segment the ROI. As still another example, the segmentation template may have a plurality of segmentation models each of which corresponds to one of the plurality of classifications (or one of the plurality of ROI identifiers). Merely by way of example, the segmentation model(s) may include a first segmentation model and a second segmentation model. The first segmentation model may correspond to the first classification (or first identifier) and include first segmentation algorithm(s) for segmenting the target(s) of the subject, and the second segmentation model may correspond to the second classification (or second identifier) and include second segmentation algorithm(s) for segmenting the OAR(s) of the subject. The first segmentation algorithm(s) for segmenting the target(s) may be the same as or different from the second segmentation algorithm(s) for segmenting the OAR(s).

According to some embodiments of the present disclosure, different ROIs may have different corresponding segmentation models. When a segmentation model includes one segmentation algorithm corresponding to a single ROI, the difficulty for generating the segmentation model may be reduced, and the needed computing resource for using the segmentation model to implement the segmentation may be reduced.

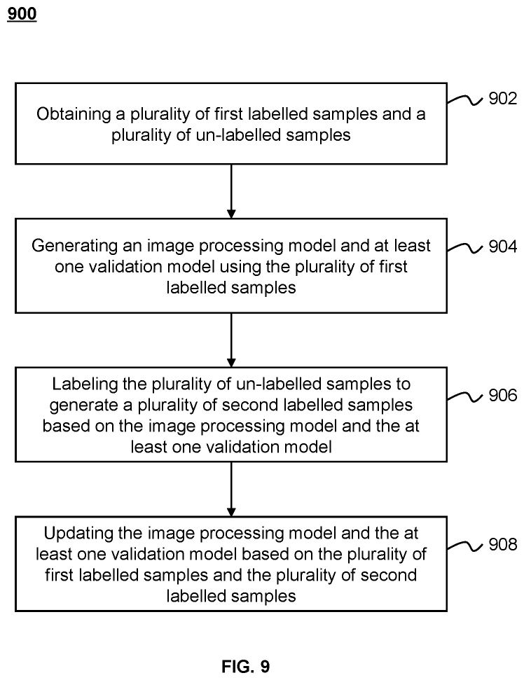

In some embodiments, a segmentation model may be obtained by training an initial model using a plurality of labelled samples. The plurality of labelled samples may be obtained by automatically labelling a plurality of un-labelled samples. For example, the processing device 140 may obtain a plurality of pre-labelled samples and a plurality of un-labelled samples, generate the segmentation model and at least one validation model using the plurality of pre-labelled samples, and label the plurality of un-labelled samples to generate the plurality of labelled samples based on the segmentation model and the at least one validation model. More descriptions regarding the obtaining of the segmentation model may be found in elsewhere in the present disclosure (e.g., FIGS. 9-17 and the descriptions thereof).

In some embodiments, after the segmentation model(s) corresponding to the segmentation template are obtained, the processing device 140 may segment the one or more target portions corresponding to the one or more ROIs from the target image using the segmentation model(s) corresponding to the segmentation template. For example, for each ROI, the processing device 140 may segment a target portion representing the ROI from the target image using the segmentation model corresponding to the ROI. In some embodiments, the processing device 140 may segment target portions of different ROIs from the target image simultaneously or sequentially.

It should be noted that a segmentation algorithm included in a segmentation model may be any existing segmentation algorithm.

In some embodiments, after a target portion representing an ROI is segmented from the target image, the processing device 140 may perform a quality control on the target portion. The quality control may include determining whether the target portion representing the ROI is empty, determining whether at least one parameter (e.g., a position, a shape, a volume, etc.) of the target portion satisfies certain constrain(s), etc. For example, the processing device 140 may first determine whether the target portion representing the ROI is empty. If the result of the target portion representing the ROI is empty, the processing device 140 may delete the empty result. If the result of the target portion representing the ROI is not empty, the processing device 140 may determine whether an area of the target portion is within a suitable range. If the at least one parameter of the target portion satisfies the certain constrain(s), the processing device 140 may output the target portion as a segmentation result. In response to that the at least one parameter of the target portion doesn't satisfy the certain constrain(s), the processing device 140 may output a prompt.

In some embodiments, operation 406 may be performed by the GPU 204 of the processing device 140, and the quality control on the one or more target portions may be performed by other hardware processors (e.g., the CPU 202). For example, after the GPU 204 segments the one or more target potions, the CPU 202 of the processing device 140 may perform the quality control on the one or more target portions. Therefore, the GPU 204 of the processing device 140 may perform no operations (e.g., obtain the target image, perform the quality control) other than performing the image segmentation, thereby improving the efficiency of the image segmentation, and ensuring the timeliness of the image segmentation on the plurality of target images. In addition, since the image segmentation is performed by the GPU 204, few resources of the CPU 202 may be occupied, so that the image segmentation is hardly affected by a working state of the CPU 202, thereby further ensuring the timeliness of the image segmentation.

In some embodiment, when there are a plurality of target images need to be segmented, the processing device 140 may use a serial strategy or a parallel strategy to segment the plurality of target images. For example, the processing device 140 may segment the plurality of target images one by one. Alternatively, the processing device 140 may segment two or more target images of the plurality of target images at the same time. By using the parallel strategy, the utilization efficiency of computing resources may be improved, thereby improving the efficiency of image segmentation.

In some embodiments of the present disclosure, the segmentation template corresponding to the segmentation range may be determined, which may establish a connection between the segmentation range and the corresponding ROIs, thereby improving the efficiency of determining the ROIs in the segmentation range. Further, the target portion representing the ROI may be segmented from the target image using the segmentation model corresponding to the segmentation template, thereby improving the efficiency and flexibility of the image segmentation.

In addition, the segmentation template(s) corresponding to the segmentation range(s) and the corresponding segmentation model(s) may be previously generated and stored in a storage device. When a target segmentation range is determined, the corresponding segmentation template(s) and segmentation model(s) may be obtained from the storage device based on the target segmentation range, which may improve the efficiency of the image segmentation.

It should be noted that the description of the process 400 is provided for the purposes of illustration, and is not intended to limit the scope of the present disclosure. For persons having ordinary skills in the art, various variations and modifications may be conducted under the teaching of the present disclosure. For example, an additional operation for displaying the target portion(s) representing the ROI(s) may be added after operation 406. However, those variations and modifications may not depart from the protection of the present disclosure.

FIG. 5 is a flowchart illustrating an exemplary process 500 for determining a segmentation template corresponding to a segmentation range according to some embodiments of the present disclosure. In some embodiments, the process 500 may be performed to achieve at least part of operation 404 as described in connection with FIG. 4.

In 502, the processing device 140 (e.g., the determination module 302) may obtain a plurality of segmentation templates.

Each of the plurality of segmentation templates may correspond to one of a plurality of reference segmentation ranges. The plurality of reference segmentation range may be pre-determined based on one or more ROIs. For example, as shown in FIG. 5, the segmentation templates may include a segmentation template T1 corresponding to the head and a segmentation template T2 corresponding to the abdomen. The segmentation template T1 corresponding to the head may include a list of ROIs in the head, which includes the ROI₁, ROI₂, and ROI₃, and the segmentation template T2 corresponding to the abdomen may include a list of ROIs in the abdomen, which includes the ROI_{A}, ROI_{B}, and ROI_{C}.

In some embodiments, one reference segmentation range may correspond to multiple segmentation templates. For example, for a specific reference segmentation range, the corresponding multiple segmentation templates may be generated based on a gander, an age, etc. Merely by way of example, if the reference segmentation range is the abdomen, the corresponding segmentation templates may include a male segmentation template and a female segmentation template.

In some embodiments, the segmentation templates may include a general segmentation template, a custom segmentation template, a special segmentation template, or the like, or any combination thereof. The general segmentation template (also referred to as a preset segmentation template) may refer to a segmentation template that is designed by an organization (e.g., a vender, a hospital) according to general information (e.g., a scanned part, a gender, etc., of a subject). The custom segmentation template may refer to a segmentation template that is designed by a user (e.g., a doctor) according to his/her preference or need. The special segmentation template may refer to a segmentation template corresponding to a special group of subjects. For example, a first special segmentation template may correspond to a first special group of patients that have an artificial hip joint, and a second special segmentation template may correspond to a special group of patients that have removed a certain organ.

In some embodiments, the ROI(s) in the segmentation template may be classified into a plurality of classifications having a plurality of ROI identifiers. Merely by way of example, the ROIs may be classified into a first classification corresponding to targets and a second classification corresponding to OARs. The first classification and the second classification may correspond to a first ROI identifier and a second ROI identifier, respectively.

In some embodiments, the segmentation templates may be previously generated based on the reference segmentation ranges, and stored in a storage device (e.g., the storage device 150). The processing device 140 may obtain the segmentation templates from the storage device.

In 504, the processing device 140 (e.g., the determination module 302) may select, from the segmentation templates, the segmentation template corresponding to the segmentation range.

Different segmentation ranges may include different ROIs having different shapes and/or sizes. For example, geometric shapes of different tumors and/or OARs may be different. Exemplary shapes of tumors may include a polypoid shape, a papillary shape, a villous shape, a nodular shape, a lobulated shape, a cystic shape, a cauliflower shape, a mushroom shape, or the like, or any combination thereof. Exemplary shapes of OARs may include a block, a strip, etc. As another example, sizes of tumors in the head or the neck (e.g., thyroid tumors, ear-nose-throat (ENT) tumors, oral and maxillofacial tumors, etc.) may be smaller than sizes of tumors in the chest or the abdomen. OARs in the head or the neck may also have smaller sizes than OARs in the chest or the abdomen. Therefore, determining ROIs in different segmentation ranges by using a same segmentation template may reduce an accuracy of the determination.

In some embodiments, the processing device 140 may select the segmentation template corresponding to the segmentation range from the segmentation templates. For example, if the segmentation range includes a chest, the processing device 140 may select a general segmentation template corresponding to the chest, or a custom segmentation template corresponding to the chest, or a special segmentation template corresponding to the chest.

In some embodiments, the processing device 140 may obtain reference information regarding the subject. The reference information regarding the subject may include gender information, age information, height and weight information, radiotherapy information, biological information, or the like, or any combination thereof. For example, the processing device 140 may obtain the reference information based on the tag information of the target image. As another example, the reference information may be input by the user.

Further, the processing device 140 may select the segmentation template corresponding to the segmentation range from the segmentation templates based on the reference information. Merely by way of example, a segmentation range that includes a preset sex organ may correspond to at least two segmentation templates. The preset sex organ may include a breast, a uterus, a prostate, etc. While determining the segmentation range, tag information including gender information may be obtained, and a segmentation template may be determined from the at least two segmentation templates based on the gender information. For instance, if it is determined that the segmentation range of the target image includes a lower abdomen, the tag information including the gender information may be obtained. If the gender information indicates that the subject is female, a segmentation template suitable for the female may be selected as the segmentation template corresponding to the segmentation range. If the gender information indicates that the subject is male, a segmentation template suitable for the male may be selected as the segmentation template corresponding to the segmentation range. As another example, if it is determined that the segmentation range of the subject is the abdomen and the reference information indicates that the pancreas of the subject have been removed, a special segmentation template corresponding to the abdomen of patients whose pancreas of the subject have been removed may be selected. Therefore, the segmentation template corresponding to the segmentation range may be determined based on the reference information, which may not only simplify the determination process of the segmentation template, but also improve the accuracy of the determined segmentation template.

In some embodiments, the processing device 140 may select the custom segmentation template corresponding to the segmentation range based on user information. The user information may include preference or need of the user. Merely by way of example, when the user logins his/her identification, the processing device 140 may obtain the user information. While determining the segmentation range, the processing device 140 may determine the custom segmentation template corresponding to the segmentation range based on the gender information.

According to some embodiments of the present disclosure, the at least one segmentation template corresponding to the segmentation range may be determined based on the segmentation range, the reference information, and/or the user information, thereby improving the flexibility and accuracy of determining the segmentation template. In addition, the determined segmentation template(s) may satisfy the preference or need of the user, which may reduce operations of the user and improve the satisfaction of the user.

FIG. 6 is a schematic diagram illustrating an exemplary process 600 for segmenting a target portion according to some embodiments of the present disclosure.

As shown in FIG. 6, a target image 610 of a subject may be input into a recognition model 620. The recognition model 620 may be used to determine a segmentation range from the target image 610. Further, a segmentation template corresponding to the segmentation range may be determined based on reference information 630. A segmentation model 640 corresponding to the segmentation template may be determined. A target portion 650 corresponding to an ROI may be segmented from the target image 610 using the segmentation model 640.

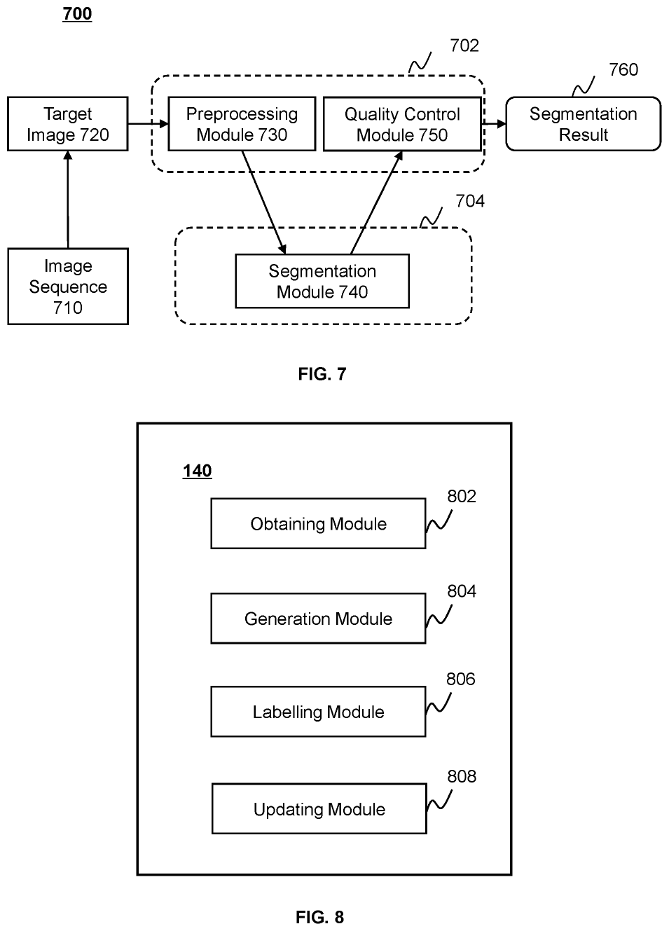

FIG. 7 is a schematic diagram illustrating an exemplary process 700 for obtaining a segmenting result according to some embodiments of the present disclosure.

As shown in FIG. 7, a CPU 702 may obtain a target image 720 from an image sequence 710 including a plurality of candidate images. After the target image 720 is obtained, a preprocessing module 730 in the CPU 702 may preprocess the target image 720. A GPU 704 may send an image acquisition request to the CPU 702 to obtain the preprocessed target image. In response to the image acquisition request, the CPU 702 may send the preprocessed target image 720 to the GPU 704, and the GPU 704 may receive the preprocessed target image 720. In some embodiments, when the GPU 704 has an idle thread currently, the GPU 704 may send the image acquisition request to the CPU 702, and the CPU 702 may send the first candidate image in the image sequence 710 to the GPU 704 as the target image 720, and the GPU 704 may receive the target image 720. A segmentation module 740 in the GPU 704 may segment at least one target portion representing at least one ROI from the preprocessed target image. Further, a quality control module 750 of the CPU 702 may perform quality control on the target portion to generate a segmentation result 760.

FIG. 8 is a block diagram illustrating an exemplary processing device 140 according to some embodiments of the present disclosure. In some embodiments, the processing device 140 may be in communication with a computer-readable storage medium (e.g., the storage device 150 illustrated in FIG. 1) and may execute instructions stored in the computer-readable storage medium. The processing device 140 may include an obtaining module 802, a generation module 804, a labelling module 806, and an updating module 808.

The obtaining module 802 may be configured to obtain a plurality of first labelled samples and a plurality of un-labelled samples. A first labelled sample may refer to a high-quality labelled sample. An un-labelled sample may refer to a sample that needs to be labelled or a sample whose label needs to be modified or confirmed. More descriptions regarding the obtaining of the plurality of first labelled samples and the plurality of un-labelled samples may be found elsewhere in the present disclosure. See, e.g., operation 902 and relevant descriptions thereof.

The generation module 804 may be configured to generate an image processing model and at least one validation model using the first labelled samples. The image processing model may be configured to process an image. The at least one validation model may be configured to verify the image processing model. That is, the at least one validation model may be configured to determine whether the trained image processing model can accurately perform a corresponding image processing. In some embodiments, the at least one validation model may include a first validation model and/or a second validation model. More descriptions regarding the generation of the image processing model and the at least one validation model may be found elsewhere in the present disclosure. See, e.g., operation 904 and relevant descriptions thereof.

The labelling module 806 may be configured to label the un-labelled samples to generate a plurality of second labelled samples based on the image processing model and the at least one validation model. A second labelled sample may refer to a labelled sample that is generated by labelling a corresponding un-labelled sample based on the image processing model and the at least one validation model. More descriptions regarding the labelling of the un-labelled samples may be found elsewhere in the present disclosure. See, e.g., operation 906 and relevant descriptions thereof.

The updating module 808 may be configured to update the image processing model and the at least one validation model based on the first labelled samples and the second labelled samples. In some embodiments, the second labelled samples may be used to update the first labelled samples. In some embodiments, the updating module 808 may further update the image processing model and/or the at least one validation model based on a target image. More descriptions regarding the updating of the image processing model and the at least one validation model may be found elsewhere in the present disclosure. See, e.g., operation 908 and relevant descriptions thereof.

FIG. 9 is a flowchart illustrating an exemplary process for training sample labelling according to some embodiments of the present disclosure. Process 900 may be implemented in the system 100 for image segmentation illustrated in FIG. 1. For example, the process 900 may be stored in the storage device 150 in the form of instructions (e.g., an application), and invoked and/or executed by the processing device 140 (e.g., the processing device 140 illustrated in FIG. 1, the CPU 202 or the GPU 204 illustrated in FIG. 2, or one or more modules in the processing device 140 illustrated in FIG. 8.

As used herein, labelling a training sample refers to a process of assigning a training labelling for the training sample. For example, the training sample may include a sample image, and the training label of the sample image may include a classification of the sample image, an ROI contour marked out from the sample image, an object included in the sample image, or the like, or any combination thereof.

At present, machine learning models (e.g., deep learning models) are widely used in various fields. In order to obtain an accurate machine learning model, a preliminary model may be trained with a large count of high-quality labelled samples. However, the high-quality labelled samples may be obtained by manually labelling training samples, which requires a lot of manpower. For example, although great progress has been made in the use of trained segmentation models to segment medical images, the generation of the trained segmentation models still relies on high-quality labelled samples (e.g., images in which ROI contours are marked out) that are difficult to acquire. For example, it is difficult to obtain clinical images for model training since clinical images include private information regarding patients, and a strict data use agreement needs to be signed with hospitals. In addition, even though some clinical images have been labelled by doctors in medical diagnoses or research, these clinical images cannot be used in model training directly because different hospitals and doctors have different labelling habits. Clinical images have to be labelled by senior doctors according to a uniform standard or labelled clinical images have to be confirmed by senior doctors to generate high-quality labelled samples, which requires a lot of manpower. In order to reduce the manpower and improve the efficiency of obtaining high-quality labelled samples, the process 900 may be performed.

In 902, the processing device 140 (e.g., the obtaining module 802) may obtain a plurality of first labelled samples and a plurality of un-labelled samples.

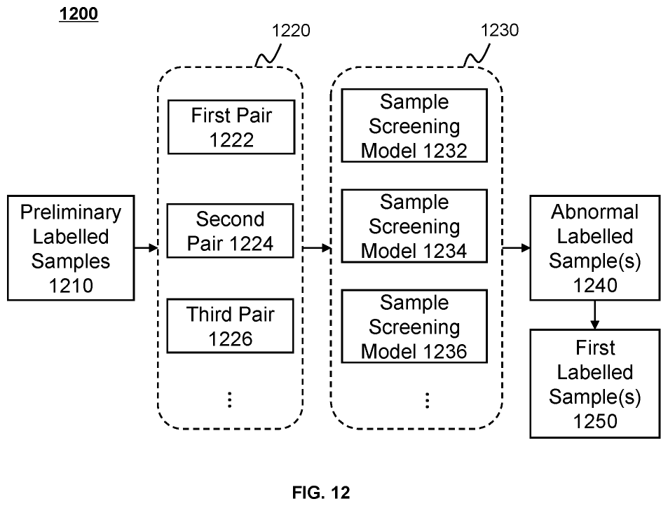

A first labelled sample may refer to a high-quality labelled sample. For example, the first labelled sample may be labelled or confirmed by a target user (e.g., a senior doctor). Alternatively, the accuracy of the first labelled sample may have been verified, for example, by sample screen models (which will be described in detail in connection with FIG. 12). In some embodiments, each first labelled sample may include a sample image and a corresponding labelled sample image. The labelled sample image may be generated by manually labelling the sample image. For example, the contour of a specific ROI may be marked out in the labelled sample image.

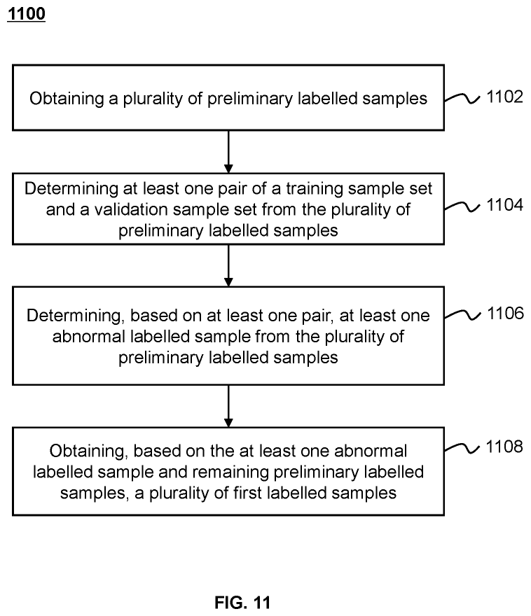

In some embodiments, the processing device 140 may obtain the first labelled samples from a storage device (e.g., the storage device 150 or an external storage) that stores the first labelled samples. In some embodiments, the processing device 140 may obtain a plurality of preliminary labelled samples from a storage device (e.g., the storage device 150 or an external storage) that stores the preliminary labelled samples, and further determine the first labelled samples based on the preliminary labelled samples. More descriptions regarding the obtaining of the first labelled samples may be found in elsewhere in the present disclosure (e.g., FIGS. 11 and 12, and the descriptions thereof).

An un-labelled sample may refer to a sample that needs to be labelled or a sample whose label needs to be modified or confirmed. In some embodiments, the un-labelled sample may only include a sample image. In some embodiments, the un-labelled sample may include a sample image and a preliminary labelled sample image that needs to be modified or confirmed. For example, the preliminary labelled sample image may be generated using a trained segmentation model or algorithm. As another example, the preliminary labelled sample image may be generated by one or more users (e.g., junior doctors) other than the target user(s) who label the first labelled samples.

In some embodiments, the processing device 140 may obtain the un-labelled samples from a storage device (e.g., the storage device 150 or an external storage) that stores the un-labelled samples. In some embodiments, the processing device 140 may obtain a plurality of preliminary un-labelled samples from a storage device, and one or more target users may label a portion of the preliminary un-labelled samples, wherein the labelled portion of the preliminary un-labelled samples may be designated as the first labelled samples (or the preliminary labelled samples), and the remaining portion of the preliminary un-labelled samples may be designated as the un-labelled samples.

In some embodiments, the first labelled samples may be less than the un-labelled samples. For example, a ratio of a count of the first labelled samples to a count of the un-labelled samples may be 1:5, 1:6, 1:8, 1:10, 1:15, 1:20, etc. As another example, the count of the first labelled samples may be 30, and the count of the un-labelled samples may be any count larger than 30.

In 904, the processing device 140 (e.g., the generation module 804) may generate an image processing model and at least one validation model using the first labelled samples.

The image processing model may be configured to process an image. For example, the image processing model may include a segmentation model (e.g., the segmentation model 640), a recognition model, a classification model, or the like, or any combination thereof. The type of the image processing model may be determined based on actual requirements.

In some embodiments, the processing device 140 may generate the image processing model by training an initial image processing model using the first labelled samples. In some embodiments, the initial image processing model may be an initial model (e.g., a neural network model) before being trained. Exemplary neural network models may include a convolutional neural network (CNN) model, a recurrent neural network (RNN) model, a long short term memory (LSTM) network model, a fully convolutional neural network (FCN) model, a generative adversarial network (GAN) model, a Hopfield model, a dilated convolution model, a conditional random fields as recurrent neural networks (CRFasRNN) model, or the like, or any combination thereof. Merely by way of example, the processing device 140 may generate the image processing model according to a supervised machine learning algorithm by performing one or more iterations to iteratively update model parameter(s) of the initial image processing model using the first labelled samples. For each first labelled sample, the sample image may be an input of the initial image processing model, and the corresponding labelled sample image may be a training label of the initial image processing model.

The at least one validation model may be configured to verify the image processing model. That is, the at least one validation model may be configured to determine whether the trained image processing model can accurately perform a corresponding image processing. For example, if the image processing model is the segmentation model, the at least one validation model may be configured to determine whether an image input into the segmentation model is accurately segmented. As another example, if the image processing model is the classicization model, the at least one validation model may be configured to determine whether an image input into the recognition model is accurately classified.

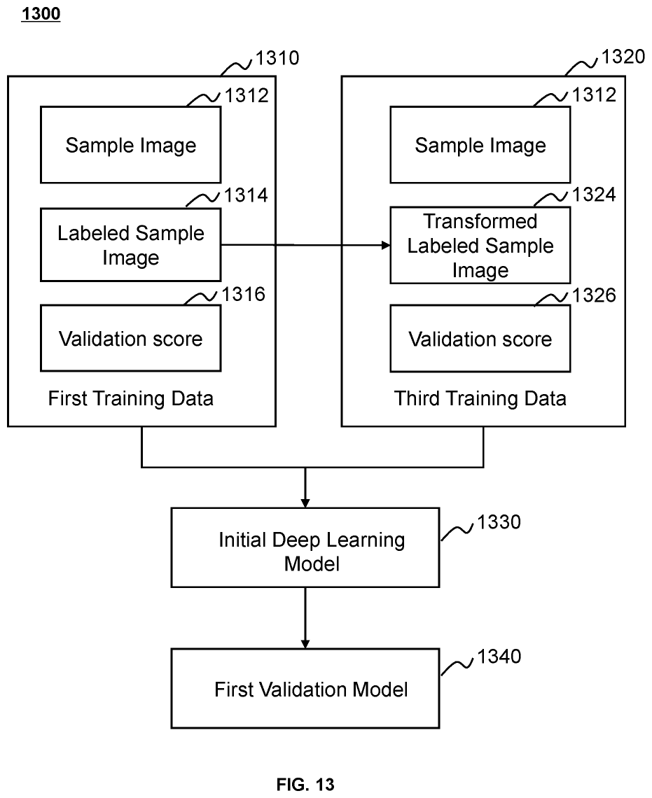

In some embodiments, the at least one validation model may include a first validation model and/or a second validation model. The first validation model may include a deep learning model. Exemplary deep learning models may include a deep belief network (DBN) model, a stacked autoencoders (SAE) model, a CNN model, an RNN model, or the like, or any combination thereof. In some embodiments, the first validation model may be generated by training an initial deep learning model. For example, the processing device 140 may determine first training data of the first validation model that includes the sample image, the labelled sample image, and a first validation score regarding the labelled sample image of each first labelled sample. The processing device 140 may further generate the first validation model by training the initial deep learning model using the first training data. More descriptions regarding the generation of the first validation model may be found in elsewhere in the present disclosure (e.g., FIG. 13 and the descriptions thereof).

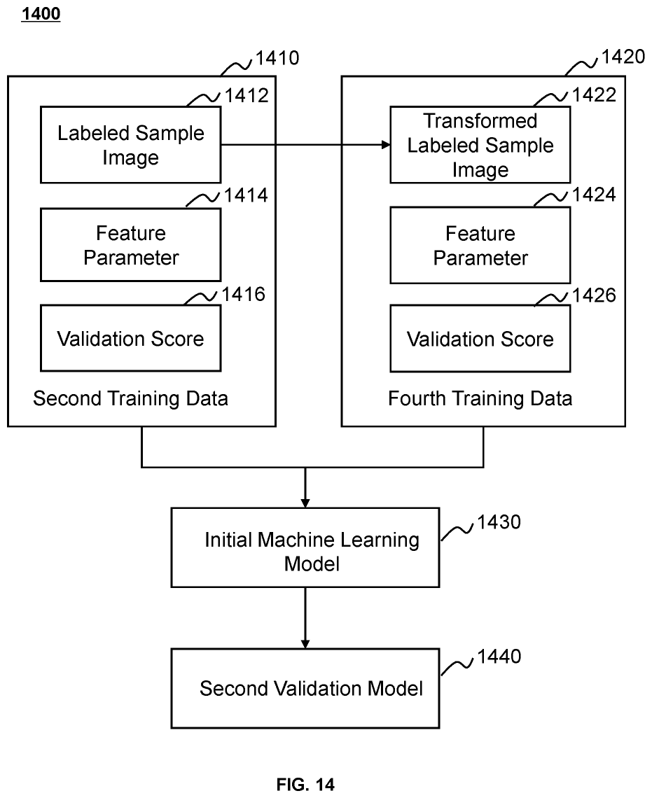

The second validation model may include a machine learning model. Exemplary machine learning models may include a naive Bayes model, a decision tree model, a K-nearest neighbour (KNN) model, a support vector machine (SVM) model, a logistic regression model, or the like, or any combination thereof. In some embodiments, the second validation model may be generated by training an initial machine learning model. For example, the processing device 140 may determine second training data of the second validation model that includes at least one feature parameter of the labelled sample image and the first validation score regarding the labelled sample image of each first labelled sample. The processing device 140 may further generate the second validation model by training the initial machine learning model using the second training data. More descriptions regarding the generation of the second validation model may be found in elsewhere in the present disclosure (e.g., FIG. 14 and the descriptions thereof).

In 906, the processing device 140 (e.g., the labelling module 806) may label the un-labelled samples to generate a plurality of second labelled samples based on the image processing model and the at least one validation model.

A second labelled sample may refer to a labelled sample that is generated by labelling a corresponding un-labelled sample based on the image processing model and the at least one validation model.

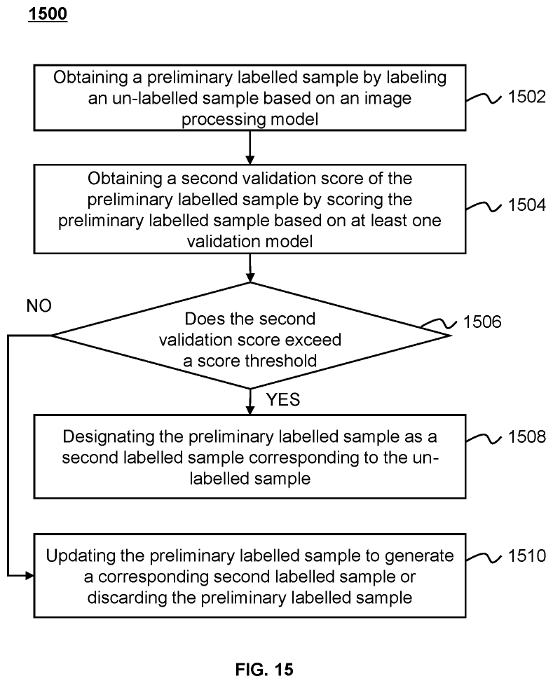

Merely by way of example, for each of the un-labelled samples, the processing device 140 may obtain a preliminary labelled sample by labelling the un-labelled sample based on the image processing model, and determine a second validation score of the preliminary labelled sample by scoring the preliminary labelled sample based on the at least one validation model. Further, based on the second validation score, the processing device 140 may designate the preliminary labelled sample as a second labelled sample, or further update the preliminary labelled sample to generate the corresponding second labelled sample, or discard the preliminary labelled sample. More descriptions regarding the generation of the second labelled sample may be found in elsewhere in the present disclosure (e.g., FIG. 15 and the descriptions thereof).

In 908, the processing device 140 (e.g., the updating module 808) may update the image processing model and the at least one validation model based on the first labelled samples and the second labelled samples.

Since the second labelled samples have been verified using the at least one validation model, the second labelled samples may be regarded as high-quality labelled samples. Therefore, the second labelled samples may be used to update the image processing model and the at least one validation model. For example, based on the first labelled samples and the second labelled samples, the processing device 140 may re-train the initial image processing model to generate the updated image processing model; and re-train the initial deep learning model and/or the initial machine learning model to generate the at least one updated validation model.

In some embodiments, the second labelled samples may be used to update the first labelled samples. For example, a plurality of updated first labelled samples may be generated by adding the second labelled samples to the first labelled samples. Accordingly, the image processing model and the at least one validation model may be updated based on the updated first labelled samples.

In some embodiments, the processing device 140 may further update the image processing model and/or the at least one validation model based on a target image. For example, the processing device 140 may obtain a processing result by processing the target image using the updated image processing model, generate a modified processing result by modifying the processing result based on a modification instruction inputted by the user, and determine a third validation score of the processing result and a fourth validation score of the modified processing result based on the at least one updated validation model. Further, the processing device 140 may determine whether a difference between the third validation score and the fourth validation score exceeds a difference threshold. If the difference exceeds the difference threshold, the processing device 140 may update the image processing model and the at least one validation model based on the target image, the first labelled samples, and the second labelled samples. If the difference doesn't exceed the difference threshold, the processing device 140 may continue to use the image processing model and the at least one validation model.

Merely by way of example, during a diagnosis operation or a treatment operation, the target image (e.g., a diagnosis image, a scanned image, etc.) of the subject may be obtained by scanning the subject. The user may determine ROI(s) based on the target image. For example, the user may segment target portion(s) corresponding to the ROI(s) from the target image. As another example, the user may determine whether the processing result generated by the image processing model needs to be modified. If the processing result needs to be modified, the user may modify the processing result. If the processing result doesn't need to be modified, the user may retain the processing result. Subsequently, the use may input the target portion(s) (or the modified processing result) as the modification instruction. That is, a new high-quality labelled sample may be added to train the image processing model and the at least one validation model. The new high-quality labelled sample may be generated according to the daily work of the user, which needs no extra time, thereby improving the convenience of the labelling and the training. In addition, the high-quality labelled samples may be updated continually, which may improve the accuracy of the image processing model and the validation model.

Some embodiments of the present disclosure, the image processing model and the at least one validation model may be generated using the first labelled samples, and the un-labelled samples may be labelled to generate the second labelled samples based on the image processing model and the at least one validation model. The training sample labelling methods may only involve limited user intervention to obtain the original first labelled samples, and other un-labelled samples can be automatically labelled with little or no direct human intervention. Thus, the training sample labelling methods disclosed herein may be more accurate and efficient by, e.g., reducing the workload of users, cross-user variations, and the time needed for the training sample labelling. In addition, the second labelled samples and the first labelled samples may be used to update the image processing model and the at least one validation model, and the updated image processing model and the at least one updated validation model having improved accuracies may be put into practical application.

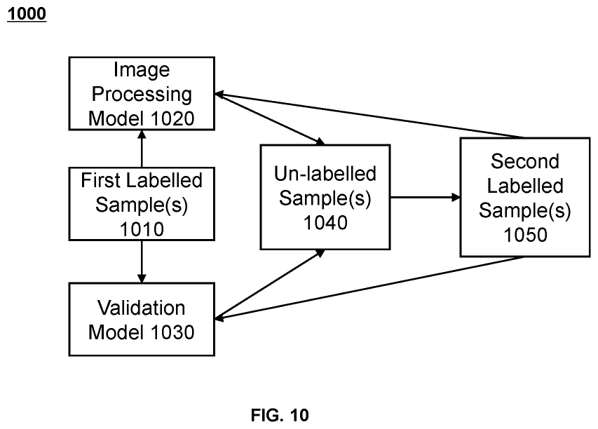

FIG. 10 is a schematic diagram illustrating an exemplary process 1000 for training sample labelling according to some embodiments of the present disclosure.

As shown in FIG. 10, first labelled sample(s) 1010 may be used to generate an image processing model 1020 and at least one validation model 1030. Un-labelled sample(s) 1040 may be labelled to generate second labelled sample(s) 1050 based on the image processing model 1020 and the at least one validation model 1030. The second labelled sample(s) 1050 and the first labelled sample(s) 1010 may be used to update the image processing model 1020 and the at least one validation model 1030.

FIG. 11 is a flowchart illustrating an exemplary process 1100 for obtaining a plurality of first labelled samples according to some embodiments of the present disclosure. In some embodiments, the process 1100 may be performed to achieve at least part of operation 902 as described in connection with FIG. 9.

In 1102, the processing device 140 (e.g., the obtaining module 802) may obtain a plurality of preliminary labelled samples.

A preliminary labelled sample may refer to a labelled sample that needs to be verified. The preliminary labelled sample may be determined as a first labelled sample, or modified to generate a corresponding first labelled sample, or discarded according to its verification result. For example, the processing device 140 may screen the preliminary labelled samples to obtain a plurality of first labelled samples.

In some embodiments, the processing device 140 may obtain the preliminary labelled samples from a storage device (e.g., the storage device 150 or an external storage) that stores the preliminary labelled samples. For example, a user may label the preliminary labelled samples, and the preliminary labelled samples may be stored in the storage device 150. The processing device 140 may obtain the preliminary labelled samples by retrieving the storage device 150.

In 1104, the processing device 140 (e.g., the obtaining module 802) may determine at least one pair of a training sample set and a validation sample set from the preliminary labelled samples.

In some embodiments, the processing device 140 may determine a portion of the preliminary labelled samples as a training sample set, and determine a remaining portion of the preliminary labelled samples as a corresponding validation sample set. In such cases, the training sample set and the corresponding validation sample set may be regarded as one pair.

In some embodiments, the processing device 140 may determine a plurality of sample sets from the preliminary labelled samples. A count of the sample sets may be any positive integer, such as, 3, 5, 8, 10, 15, 20, etc. For example, the processing device 140 may perform a grouping operation on the preliminary labelled samples to obtain the sample sets. In some embodiments, different sample sets may have the same count of preliminary labelled samples. That is, the processing device 140 may perform an even grouping operation on the preliminary labelled samples. In some embodiments, different sample sets may have different counts of preliminary labelled samples. That is, the processing device 140 may perform an uneven grouping operation on the preliminary labelled samples.

Further, the processing device 140 may determine the at least one pair based on the sample sets. For example, the processing device 140 may designate one sample set from the sample sets as a validation sample set, and designate the remaining sample set(s) as a corresponding training sample set. In some embodiments, a count of the at least one pair may be equal to or less than the count of the sample sets. For example, when each of the sample sets is designated as one validation sample set, the count of the at least one pair may be equal to the count of the sample sets. As another example, when a portion of the sample sets is designated as validation sample sets, respectively, the count of the at least one pair may be less than the count of the sample sets.

Merely by way of example, the processing device 140 may perform the grouping operation on the preliminary labelled samples to obtain a first sample set, a second sample set, and a third sample set. The processing device 140 may obtain a first pair by designating the first sample set as a first validation sample set of the first pair, and designating the second sample set and the third sample set as a first training sample set of the first pair. The processing device 140 may obtain a second pair by designating the second sample set as a second validation sample set of the second pair, and designating the first sample set and the third sample set as a second training sample set of the second pair. The processing device 140 may obtain a third pair by designating the third sample set as a third validation sample set of the third pair, and designating the first sample set and the second sample set as a third training sample set of the third pair.

In 1106, the processing device 140 (e.g., the obtaining module 802) may determine, based on the at least one pair, at least one abnormal labelled sample from the preliminary labelled samples.

An abnormal labelled sample may refer to a sample whose label is likely to be inaccurate and needs further verification. For example, the label of the abnormal labelled sample may be inaccurate, and the abnormal labelled sample may be further processed (e.g., retained, modified, discarded, etc.) based on an instruction input by a user.

In some embodiments, for each of the at least one pair, the processing device 140 may generate at least one sample screening model using the corresponding training sample set and the corresponding validation sample set. The at least one sample screening model may be configured to determine whether a preliminary labelled sample is an abnormal labelled sample. In some embodiments, the processing device 140 may use the corresponding training sample set and the corresponding validation sample set to train an initial image processing model to obtain the at least one sample screening model. The training may include an iterative operation including one or more iterations. For at least one of the one or more iterations, the processing device 140 may obtain an updated image processing model that is generated based on the corresponding training sample set in a previous iteration, and verify the updated image processing model using the corresponding validation sample set to generate a validation result. The validation result may indicate whether the updated image processing model satisfies a validation condition.

In some embodiments, the validation condition may include that a count of iterations is equal to or larger than a count threshold, a validation loss is not falling compared with the previous iteration, the validation loss is equal to or larger than a loss threshold, a validation performance is not rising compared with the previous iteration, the validation performance is equal to or larger than a performance threshold, or the like, or any combination thereof. For example, the validation loss may be used to measure a difference between a predicted result (e.g., a labelled image output by the updated image processing model corresponding to a sample image of a preliminary labelled sample among the validation sample set) and an actual result (e.g., a corresponding labelled image of the preliminary labelled sample among the validation sample set). The validation performance may be determined based on, e.g., a dice coefficient, a mean surface distance, a Hall's distance, etc., of the labelled image output by the updated image processing model. If the validation result indicates that the updated image processing model satisfies the validation condition, the processing device 140 may designate the updated image processing model as the sample screening model. If the validation result indicates that the updated image processing model doesn't satisfy the validation condition, the processing device 140 may further update the updated image processing model.

In some embodiments, the sample screening model may include a best model corresponding to the pair and/or a final model corresponding to the pair. The final model may refer to a model when the validation result indicates that the updated image processing model satisfies the validation condition. The best model may refer to an updated image processing model, among the updated image processing models generated in all iterations, with the maximum validation performance.

After the at least one sample screening model is generated for each pair, the processing device 140 may determine the at least one abnormal labelled sample from the preliminary labelled samples based on the at least one sample screening model. For example, the processing device 140 may input the preliminary labelled samples into the sample screening model, and the sample screening model may output the at least one abnormal labelled sample. As another example, the processing device 140 may input each of the preliminary labelled samples into the sample screening model, and the sample screening model may output a score corresponding to each of the preliminary labelled samples. Further, the processing device 140 may designate preliminary labelled samples with minimum scores as the at least one abnormal labelled sample. Merely by way of example, for each of the preliminary labelled samples, the processing device 140 may determine a score of the preliminary labelled sample corresponding to each of the sample screening models, and then determine an average score of the scores. Further, the processing device 140 may sort average scores of the preliminary labelled samples. Preliminary labelled samples corresponding to the minimum 10%-15% average scores may be determined as the at least one abnormal labelled sample. Alternatively, a certain count (e.g., 2, 3, etc.) of the preliminary labelled samples with the minimum average scores may be determined as the at least one abnormal labelled sample. In some embodiments, the processing device 140 may determine an average score threshold, and determine the at least one abnormal labelled sample based on the average score threshold. For example, if an average score of a preliminary labelled sample is less than the average score threshold, the preliminary labelled sample may be determined as an abnormal labelled sample. If the average score of the preliminary labelled sample is larger than or equal to the average score threshold, the preliminary labelled sample may be determined as a first labelled sample. The average score threshold may be determined manually, or set according to system default.

In 1108, the processing device 140 (e.g., the obtaining module 802) may obtain, based on the at least one abnormal labelled sample and remaining preliminary labelled samples, the first labelled samples.

The remaining preliminary labelled samples may refer to preliminary labelled samples in the preliminary labelled samples other than the at least one abnormal labelled sample. In some embodiments, the processing device 140 may designate the remaining preliminary labelled samples as the first labelled samples.

In some embodiments, the processing device 140 may process the at least one abnormal labelled sample. For example, the processing device 140 may discard an abnormal labelled sample or modify a label of the abnormal labelled sample based on an instruction input by the user. The modified abnormal labelled sample may be designated as a first labelled sample. Alternatively, after one or more abnormal labelled samples are modified, the sample screening model(s) may be updated based on the one or more modified abnormal labelled samples and the remaining preliminary labelled samples, and the updated sample screening model(s) may filter abnormal labelled samples from the preliminary labelled samples again. The sample screening model updating and the abnormal labelled sample filtering may be performed repeatedly until no abnormal labelled samples exist. Then, the modified abnormal labelled samples and the remaining preliminary labelled samples may be designated as the first labelled samples.

According to some embodiments, the first labelled samples may be obtained based on the preliminary labelled samples by performing the process 800, which may ensure that each of the first labelled samples is labelled accurately, thereby improving the accuracy of the image processing model and the at least one verification model subsequently generated using the first labelled samples. Further, a plurality of un-labelled samples may be labelled accurately to generate a plurality of second labelled samples (i.e., high-quality labelled samples) based on the accurate image processing model and the accurate at least one verification model.

FIG. 12 is a schematic diagram illustrating an exemplary process 1200 for generating a plurality of first labelled samples according to some embodiments of the present disclosure.

As shown in FIG. 12, a grouping operation may be performed on preliminary labelled samples 1210 to generate at least one pair 1220 of a training sample set and a validation sample set. The at least one pair 1220 may include a first pair 1222 including a first training sample set and a first validation sample set, a second pair 1224 including a second training sample set and a second validation sample set, a third pair 1226 including a third training sample set and a third validation sample set, etc. At least one sample screening model 1230 may be generated using each of the at least one pair 1220. For example, a sample screening model 1232 may be generated using the first training sample set and the first validation sample set of the first pair 1222, a sample screening model 1234 may be generated using the second training sample set and the second validation sample set of the second pair 1224, and a sample screening model 1236 may be generated using the third training sample set and the third validation sample set of the third pair 1226, etc. Abnormal labelled sample(s) 1240 may be determined, the at least one sample screening model 1230, from the preliminary labelled samples 1210. Further, first labelled sample(s) 1250 may be determined based on the abnormal labelled sample(s) 1240 and remaining preliminary labelled sample(s).

FIG. 13 is a schematic diagram illustrating an exemplary process 1300 for generating a first validation model according to some embodiments of the present disclosure. In some embodiments, the process 1300 may be performed to achieve at least part of operation 906 as described in connection with FIG. 9.

As shown in FIG. 13, a first validation model 1340 may be generated by training an initial deep learning model 1330 using first training data. The first training data may include a plurality of sets of first training data determined based on the first labelled samples as described in connection with FIG. 9. Each first labelled sample may include a sample image and a corresponding labelled sample image (e.g., an image in which the contour of an ROI is marked out). Merely by way of example, as shown in FIG. 13, a set of the first training data 1310 may correspond to a first labelled sample, and include a sample image 1312, a labelled sample image 1314, and a validation score 1316 (or referred to as a first validation score) regarding the labelled sample image 1314 of the first labelled sample. The validation score 1316 may indicate the accuracy of the labelled sample image 1314, for example, the accuracy of the marked contour of the ROI in the labelled sample image 1314. In some embodiments, the validation score 1316 may have a high value (e.g., a value exceeding a threshold) because the first labelled samples are high-quality labelled samples. In the training process, the sample image 1312 and the labelled sample image 1314 may be input into the initial deep learning model 1330; the initial deep learning model 1330 may output a predicted score of the labelled sample image 1314, and parameter value(s) of the initial deep learning model 1330 may be iteratively updated based on the predicted score and the validation score 1316. Optionally, the sample image 1312 may be omitted.

In some embodiments, the first validation model 1340 may be generated by training the initial deep learning model 1330 using the first training data and third training data. The third training data may include a plurality of sets of third training data each of which is generated based on a set of first training data. For example, as shown in FIG. 13, a set of the third training data 1320 may be generated based on the set of first training data 1310, and include the sample image 1312, a transformed sample image 1324, and a validation score 1326 regarding the transformed sample image 1324. For instance, the transformed labelled sample image 1324 may be generated based on the labelled sample image 1314, e.g., by adjusting the marked contour in the labelled sample image 1314. The validation score 1326 of the transformed labelled sample image 1324 may be determined based on the validation score 1316 and a difference between the labelled sample image 1314 and the transformed labelled sample image 1324 (e.g., a difference between the marked contours in the labelled sample image 1314 and the transformed labelled sample image). The training of the initial deep learning model 1330 using the first training data and the third training data may be similar to that using the first training data.

FIG. 14 is a schematic diagram illustrating an exemplary process 1400 for generating a second validation model according to some embodiments of the present disclosure. In some embodiments, the process 1400 may be performed to achieve at least part of operation 906 as described in connection with FIG. 9.

As shown in FIG. 14, a second validation model 1440 may be generated by training an initial machine learning model 1430 using second training data. The second training data may include a plurality of sets of second training data determined based on the first labelled samples as described in connection with FIG. 9. Each first labelled sample may include a sample image and a corresponding labelled sample image (e.g., an image in which the contour of an ROI is marked out). Merely by way of example, as shown in FIG. 14, a set of the second training data 1410 may correspond to a first labelled sample, and include a labelled sample image 1412, at least one feature parameter 1414, and a validation score 1416 (or referred to as a first validation score) regarding the labelled sample image 1412 of the first labelled sample. The at least one feature parameter 1414 may include a location, a shape, an area, etc., of a marked ROI in the labelled sample image 1412. The validation score 1416 may indicate the accuracy of the labelled sample image 1412, for example, the accuracy of the marked contour of the ROI in the labelled sample image 1412. In some embodiments, the validation score 1416 may have a high value (e.g., a value exceeding a threshold) because the first labelled samples are high-quality labelled samples. In the training process, the sample image and the labelled sample image 1412 may be input into the initial machine learning model 1430; the initial machine learning model 1430 may output a predicted score of the labelled sample image 1412, and parameter value(s) of the initial machine learning model 1430 may be iteratively updated based on the predicted score and the validation score 1416. Optionally, the sample image may be omitted.

In some embodiments, the second validation model 1440 may be generated by training the initial machine learning model 1430 using the second training data and fourth training data. The fourth training data may include a plurality of sets of fourth training data each of which is generated based on a set of second training data. For example, as shown in FIG. 14, a set of the fourth training data 1420 may be generated based on the set of second training data 1410, and include a transformed labelled sample image 1422, at least one feature parameter 1424, and a validation score 1426 regarding the transformed labelled sample image 1422. For instance, the transformed labelled sample image 1422 may be generated based on the labelled sample image 1412, e.g., by adjusting the marked contour in the labelled sample image 1412. The at least one feature parameter 1424 of the transformed labelled sample image 1422 may be extracted. The validation score 1426 of the transformed labelled sample image 1422 may be determined based on the validation score 1416 and a difference between the at least one feature parameter 1424 and the at least one feature parameter 1414. The training of the initial machine learning model 1430 using the second training data and the fourth training data may be similar to that using the second training data.

FIG. 15 is a flowchart illustrating an exemplary process 1500 for generating a second labelled sample according to some embodiments of the present disclosure. In some embodiments, the process 1500 may be performed to achieve at least part of operation 906 as described in connection with FIG. 9. In some embodiments, the process 1500 may be performed for each un-labelled sample.

In 1502, the processing device 140 (e.g., the labelling module 806) may obtain a preliminary labelled sample by labelling an un-labelled sample based on an image processing model.

The preliminary labelled sample may refer to a sample labelled based on the image processing model. Merely by way of example, the processing device 140 may input an un-labelled sample image into the image processing model. The image processing model may output a preliminary labelled image (e.g., in the form of a segmentation mask) corresponding to the un-labelled sample image. Further, the processing device 140 may determine the preliminary labelled image or the combination of the un-label sample image and the preliminary labelled image as the preliminary labelled sample.

In 1504, the processing device 140 (e.g., the labelling module 806) may determine a second validation score of the preliminary labelled sample by scoring the preliminary labelled sample based on the at least one validation model.

For example, if the at least one validation model is the first validation model, the processing device 140 may input the preliminary labelled sample (e.g., the preliminary labelled image) into the first validation model. The first validation model may output the second validation score corresponding to the preliminary labelled sample. As another example, if the at least one validation model is the second validation model, the processing device 140 may extract at least one feature parameter (e.g., a size, a shape, etc., of the unlabeled sample image, a location, a shape, an area, etc., of a marked ROI in the preliminary labelled sample, etc.) based on the preliminary labelled sample, and input the at least one feature parameter (and optionally the preliminary labelled sample) into the second validation model. The second validation model may output the second validation score corresponding to the preliminary labelled sample. As still another example, if the at least one validation model includes both the first validation model and the second validation model, the processing device 140 may obtain a preliminary second validation score A corresponding to the first validation model and a preliminary second validation score B corresponding to the second validation model, and determine the second validation score based on the two preliminary second validation scores. For instance, the processing device 140 may assign a first weight to the preliminary second validation score A and a second weight to the preliminary second validation score B, and determine the second validation score by determining a weighted sum of the preliminary second validation scores A and B. The first weight may be different from the second weight.

In 1506, the processing device 140 (e.g., the labelling module 806) may determine whether the second validation score exceeds a score threshold.

The score threshold may be used to determine whether the preliminary labelled is accurate. In some embodiments, the score threshold may be determined manually or set according to system default.

If the second validation score exceeds the score threshold, the processing device 140 may proceed to operation 1508, in which the processing device 140 may designate the preliminary labelled sample as a second labelled sample corresponding to the un-labelled sample. If the second validation score doesn't exceed the score threshold, the processing device 140 may proceed to operation 1510, in which the processing device 140 may update the preliminary labelled sample to generate a corresponding second labelled sample or discard the preliminary labelled sample. For example, the preliminary labelled sample may be sent to a user terminal, and a user may input an instruction indicating whether the preliminary labelled sample needs to be modified or discarded.

According to some embodiments of the present disclosure, a plurality of second labelled samples may be generated by labelling the un-labelled samples based on the image processing model and the at least one validation model. Since the preliminary labelled sample is verified based on the at least one validation model, the accuracy of the generated second labelled samples may be improved. In addition, the labelling the un-labelled samples based on the image processing model and the at least one validation model may reduce the labor consumption and improve the efficiency of the training sample labelling.

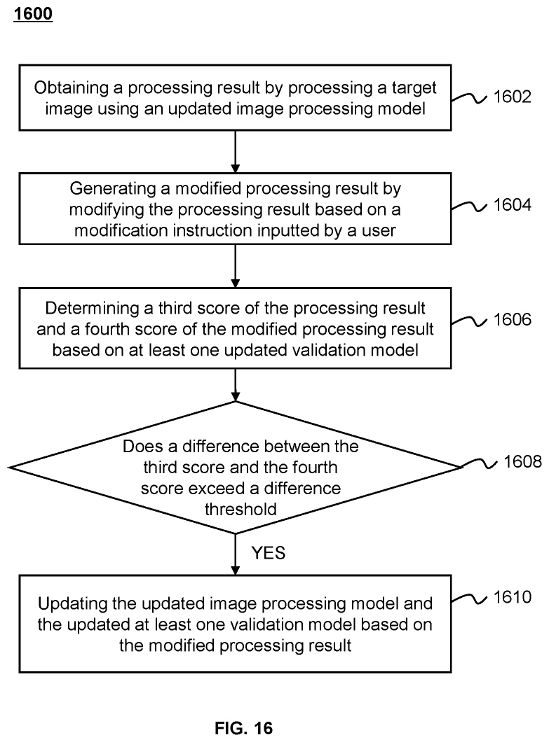

FIG. 16 is a flowchart illustrating an exemplary process 1600 for applying an updated image processing model and at least one updated validation model according to some embodiments of the present disclosure. As described in connection with operation 908, the image processing model and the at least one validation model may be updated based on the first labelled samples and the second labelled samples. In some embodiments, the updated image processing model and the at least one updated validation model may be applied in, for example, disease diagnosis, medical research, or the like. The process 1600 may be performed to further improve the accuracy of the updated image processing model and the at least one updated validation model based on the using effect and/or user feedback of the updated image processing model and the validation model.

In 1602, the processing device 140 (e.g., the updating module 808) may obtain a processing result by processing a target image using the updated image processing model.

In some embodiments, the processing device 140 may obtain the processing result by inputting the target image into the updated image processing model. For example, if the updated image processing model is a segmentation model, the processing result may include a segmented image corresponding to the target image. As another example, if the updated image processing model is a classification model, the processing result may include a classification regarding the target image.

In 1604, the processing device 140 (e.g., the updating module 808) may generate a modified processing result by modifying the processing result based on a modification instruction inputted by a user.

In some embodiments, the user may determine whether the processing result needs to be modified. If the user determines that the processing result needs to be modified, the user may input the modification instruction. For example, the processing result may include a contour marked in the target image, the user may manually modify the contour via a user terminal.

In 1606, the processing device 140 (e.g., the updating module 808) may determine a third validation score of the processing result and a fourth validation score of the modified processing result based on at least one updated validation model.

The determination of the third validation score and/or the fourth validation score may be similar to the determination of the second validation score as described in FIG. 15, which is not repeated herein.

In 1608, the processing device 140 (e.g., the updating module 808) may determine whether a difference between the third validation score and the fourth validation score exceeds a difference threshold.

If the difference exceeds the difference threshold, it may indicate that the processing result generated by the updated image processing model doesn't satisfy the user's requirement. In such cases, the processing device 140 may proceed to operation 1610, in which the processing device 140 may further update the updated image processing model and the at least one updated validation model based on the modified processing result. For example, the fourth validation score and the modified processing result may be stored. When the image processing model and the at least one validation model are updated in the background, the processing device 140 may determine the fourth validation score and the modified processing result with different weights, so that the fourth validation score and the modified processing result may be emphasized during the updating of the image processing model and the at least one validation model. If the difference doesn't exceed the difference threshold, the processing device 140 may continue to use the image processing model and the at least one validation model.

According to some embodiments of the present disclosure, the updated image processing model and the at least one updated validation model may be verified based on user feedback information collected in the actual application, and further updated if their performance doesn't satisfy user requirements. In this way, the accuracy of the updated image processing model and the at least one updated validation model may be improved to meet user requirements without spending additional time and resources on labelling new samples.

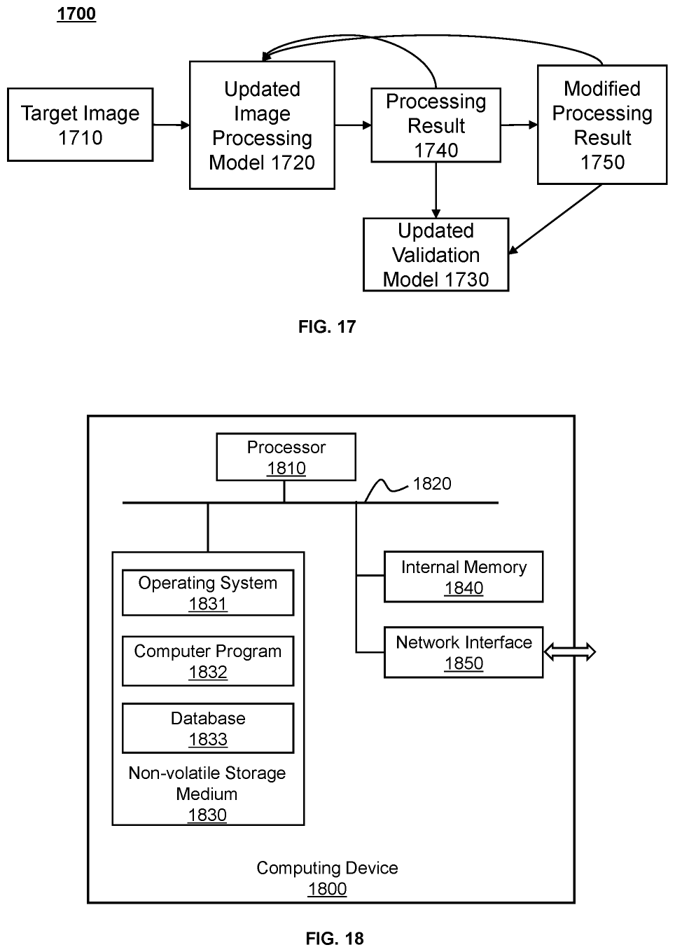

FIG. 17 is a schematic diagram illustrating an exemplary process 1700 for applying an updated image processing model and at least one updated validation model according to some embodiments of the present disclosure.

As shown in FIG. 17, a target image 1710 may be input into the updated image processing model 1720. A processing result 1740 may be generated by processing the target image 1710 using the updated image processing model 1720. A modified processing result 1750 may be generated by modifying the processing result 1740 based on a modification instruction inputted by a user. A third validation score of the processing result 1740 and a fourth validation score of the modified processing result 1750 may be determined based on at least one updated validation model 1730. Further, the updated image processing model 1720 and the updated at least one validation model 1730 may be updated based on the third validation score and the fourth validation score. For example, whether a difference between the third validation score and the fourth validation score exceeds a difference threshold may be determined. If the difference exceeds the difference threshold, the updated image processing model 1720 and the at least one updated validation model 1730 may be updated based on the modified processing result 1750.

It should be noted that the descriptions of the processes 400-600 and 1000-1700 are provided for the purposes of illustration, and not intended to limit the scope of the present disclosure. For persons having ordinary skills in the art, various variations and modifications may be conducted under the teaching of the present disclosure. For example, the processes 400-600 and 1000-1700 may be accomplished with one or more additional operations not described, and/or without one or more of the operations discussed. Additionally, the order in which the operations of the processes 400-600 and 1000-1700 is not intended to be limiting. However, those variations and modifications may not depart from the protection of the present disclosure.

FIG. 18 is a diagram illustrating an exemplary computing device according to some embodiments of the present disclosure.

In some embodiments, a computing device 1800 is provided. The computing device 1800 may be a server, and its internal components may be shown in FIG. 18. The computing device 1800 may include a processor 1810, a storage, a network interface 1850, and a database 1833 connected through a system bus 1820. The processor 1810 of the computing device 1800 may be configured to provide computing and/or control capabilities. The storage of the computing device 1800 may include a non-volatile storage medium 1830 and an internal memory 1840. The non-volatile storage medium 1830 may store an operating system 1831, computer program(s) 1832, and the database 1833. The internal memory 1840 may provide an environment for the operation of the operating system 1831 and the computer program(s) 1832 of the non-volatile storage medium 1830. The database 1833 of the computing device 1800 may be configured to store data associated with time correction (e.g., the receiving time of the valid signal, the correction information, etc.). The network interface 1850 of the computing device 1100 may be configured to communicate with an external terminal through a network connection. The computer program(s) 1832 may be executed by the processor 1810 to implement the time correction.

It will be understood by those skilled in the art that the structure shown in FIG. 18 is merely a block diagram of a part of the structure related to the present disclosure, and does not constitute a limitation on the computing device to which the present disclosure scheme is applied. The computing device 1800 may include more or fewer components than those shown in the figures, or some components may be combined, or have different component arrangements.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended for those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A method for image segmentation, comprising:
determining, from a target image of a subject, a segmentation range;
determining a segmentation template corresponding to the segmentation range, wherein the segmentation template includes a list of one or more regions of interest (ROIs) of the subject in the segmentation range; and
segmenting one or more target portions corresponding to the one or more ROIs from the target image using at least one segmentation model corresponding to the segmentation template.

2. The method of claim 1, wherein the one or more ROIs include a plurality of ROIs, and in the segmentation template, the plurality of ROIs are classified into a first classification corresponding to targets and a second classification corresponding to organs-at-risk.

3. The method of claim 1, wherein the determining, from a target image of a subject, a segmentation range includes:
determining, based on the target image, an actual size of each of at least one scanned part of the subject; and
determining, based on the actual size of each of the at least one scanned part, the segmentation range.

4. The method of claim 3, wherein determining, based on the target image, an actual size of each of at least one scanned part of the subject includes:
obtaining a recognition model;
for each of the at least one scanned part, determining a ratio of a first count corresponding to the scanned part to a second count by inputting the target image of the subject into the recognition model, the first count being a count of slices that belongs to the scanned part, the second count being a total count of slices in the target image; and
for each of the at least one scanned part, determining the actual size of the scanned part based on the corresponding ratio.

5. The method of claim 1, wherein the determining a segmentation template corresponding to the segmentation range includes:
obtaining a plurality of segmentation templates, each of the plurality of segmentation templates corresponding to one of a plurality of reference segmentation ranges; and
selecting, from the plurality of segmentation templates, the at least one segmentation template corresponding to the segmentation range.

6. The method of claim 5, wherein the selecting, from the plurality of segmentation template, at least one segmentation template corresponding to the segmentation range includes:
obtaining reference information regarding the subject; and
selecting, based on the reference information, the at least one segmentation template corresponding to the segmentation range from the plurality of segmentation template.

7. The method of claim 1, wherein the method is implemented by a central processing unit (CPU) and a graphics processing unit (GPU), and
the CPU is configured to obtain the target image; and
the GPU is configured to perform operations including:
determining, from the target image of the subject, the segmentation range;
determining the segmentation template corresponding to the segmentation range, wherein the segmentation template includes the list of the one or more ROIs of the subject in the segmentation range; and
segmenting the one or more target portions corresponding to the one or more ROIs from the target image using the at least one segmentation model corresponding to the segmentation template.

8. The method of claim 1, wherein the at least one segmentation model is obtained by training an initial model using a plurality of labelled samples, wherein
the plurality of labelled samples are obtained according to a process including:
obtaining a plurality of pre-labelled samples and a plurality of un-labelled samples;
generating the at least one segmentation model and at least one validation model using the plurality of pre-labelled samples; and
labelling the plurality of un-labelled samples to generate the plurality of labelled samples based on the segmentation model and the at least one validation model.

9. A method for training sample labelling comprising:
obtaining a plurality of first labelled samples and a plurality of un-labelled samples;
generating an image processing model and at least one validation model using the plurality of first labelled samples; and
labeling the plurality of un-labelled samples to generate a plurality of second labelled samples based on the image processing model and the at least one validation model.

10. The method of claim 9, wherein the plurality of first labelled samples are obtained according to a first process including:
obtaining a plurality of preliminary labelled samples;
determining at least one pair of a training sample set and a validation sample set from the preliminary labelled samples;
determining, based on the at least one pair, at least one abnormal labelled sample from the plurality of preliminary labelled samples; and
obtaining, based on the at least one abnormal labelled sample and remaining preliminary labelled samples, the plurality of first labelled samples.

11. The method of claim 10, wherein the determining, based on the at least one pair, at least one abnormal labelled sample includes:
for each of the at least one pair,
generating at least one sample screening model using the corresponding training sample set and the corresponding validation sample set; and
determining the at least one abnormal labelled sample from the preliminary labelled samples based on the at least one sample screening model.

12. The method of claim 11, wherein the generating at least one sample screening model using the corresponding training sample set and the corresponding validation sample set includes an iterative operation including one or more iterations, at least one of the one or more iterations including:
obtaining an updated sample screening model that is generated based on the corresponding training sample set in a previous iteration;
verifying the updated sample screening model using the corresponding validation sample set to generate a validation result; and
further updating the updated sample screening model or designating the updated sample screening model as the sample screening model based on the validation result.

13. The method of claim 9, wherein each first labelled sample includes a sample image and a corresponding labelled sample image,
the at least one validation model includes a first validation model, the first validation model is generated according to a second process including:
determining first training data of the first validation model that includes the sample image, the labelled sample image, and a first validation score regarding the labelled sample image of each first labelled sample; and
generating the first validation model by training an initial deep learning model using the first training data.

14. The method of claim 9, wherein each first labelled sample includes a sample image and a corresponding labelled sample image,
the at least one validation model includes a second validation model, the second validation model is generated according to a third process including:
determining second training data of the second validation model that includes at least one feature parameter of the labelled sample image and a first validation score regarding the labelled sample image of each first labeled sample; and
generating the second validation model by training an initial machine learning model using the second training data.

15. The method of claim 9, wherein the at least one validation model includes a first validation model and a second validation model, wherein
the first validation model is generated by training an initial deep learning model, and the second validation model is generated by training an initial machine learning model.

16. The method of claim 9, wherein the labeling the plurality of un-labelled samples to generate a plurality of second labelled samples based on the image processing model and the at least one validation model includes:
for each of the plurality of un-labelled samples,
obtaining a preliminary labelled sample by labeling the un-labelled sample based on the image processing model;
determining a second validation score of the preliminary labelled sample by scoring the preliminary labelled sample based on the at least one validation model;
determining whether the second validation score exceeds a score threshold;
in response to determining that the second validation score exceeds the score threshold, designating the preliminary labelled sample as a second labelled sample corresponding to the un-labelled sample; or
in response to determining that the second validation score doesn't exceed the score threshold, updating the preliminary labelled sample to generate a corresponding second labelled sample or discarding the preliminary labelled sample.

17. The method of claim 9, further comprising:
updating the image processing model and the at least one validation model based on the plurality of first labelled samples and the plurality of second labelled samples.

18. The method of claim 17, further comprising:
obtaining a processing result by processing a target image using the updated image processing model;
generating a modified processing result by modifying the processing result based on a modification instruction inputted by a user;
determining a third validation score of the processing result and a fourth validation score of the modified processing result based on the at least one updated validation model;
determining whether a difference between the third validation score and the fourth validation score exceeds a difference threshold; and
in response to determining that the difference exceeds the difference threshold, updating the image processing model and the at least one validation model based on the target image, the plurality of first labelled samples, and the plurality of second labelled samples.

19. A system for image segmentation, comprising:
at least one storage device including a set of instructions; and
at least one processor configured to communicate with the at least one storage device, wherein when executing the set of instructions, the at least one processor is configured to direct the system to perform operations including:
determining, from a target image of a subject, a segmentation range;
determining a segmentation template corresponding to the segmentation range, wherein the segmentation template includes a list of one or more regions of interest (ROIs) of the subject in the segmentation range; and
segmenting one or more target portions corresponding to the one or more ROIs from the target image using at least one segmentation model corresponding to the segmentation template.

20. The system of claim 19, wherein the at least one segmentation model is obtained by training an initial model using a plurality of labelled samples, wherein
the plurality of labelled samples are obtained according to a process including:
obtaining a plurality of pre-labelled samples and a plurality of un-labelled samples;
generating the at least one segmentation model and at least one validation model using the plurality of pre-labelled samples; and
labelling the plurality of un-labelled samples to generate the plurality of labelled samples based on the segmentation model and the at least one validation model.
